(19) United States
(12) Patent Application Publication
(10) Pub. No.: US 2006/0052978 A1
(43) Pub. Date: Mar. 9, 2006

(54) Wall thickness data analyzer and method

(76) Inventor: Daniel N. Hopkins, Fort Worth, TX (US)

Correspondence Address: HUNTON & WILLIAMS LLP, 1601 BRYAN STREET, ENERGY PLAZA - 30TH FLOOR, DALLAS, TX, 75201, US

(21) Appl. No.: 11/166,649

(22) Filed: Jun. 27, 2005

Related U.S. Application Data
(60) Provisional application No. 60/582,947, filed on Jun. 26, 2004.

(51) Int. Cl. G01B 11/02; G01B 13/02

(52) U.S. Cl. 702/170

(57) ABSTRACT

A wall thickness data analyzer is disclosed. The wall thickness data analyzer may comprise a storage device that stores a plurality of thickness data for a plurality of locations on the component, wherein one or more thickness data measured at specified times are provided for each location. The wall thickness data analyzer may also comprise a processor operable to access the storage device and to perform the following: partitioning the plurality of thickness data into subsets that correspond to one or more portions of the component, and determining, for a first location associated with a first portion of the component, a first wear rate according to a statistical method selected based on the number of thickness data available for the first location.

### CROSS-REFERENCE TO RELATED APPLICATIONS

This patent application claims priority to U.S. Provisional Patent Application No. 60/582,947, filed Jun. 26, 2004, which is hereby incorporated by reference herein in its entirety.

### FIELD OF THE DISCLOSURE

The present disclosure relates generally to the field of data analysis and forecasting tools. More particularly, the present disclosure relates to a wall thickness data analyzer and method.

### BACKGROUND OF THE DISCLOSURE

The wall thickness of components, such as pipes and vessels, used in industrial operations is of critical safety and operational concern. The loss of such components due to a wall failure (i.e., wall thickness falling below acceptable tolerances) can be catastrophic. Wall failures may occur when wall thickness and wear rates are not closely monitored or carefully analyzed. Such failures may result in serious personal injury and property damage as well as considerable economic losses. For example, high pressure water and steam pipes at a steam electric station or a nuclear power plant are often subject to flow accelerated corrosion (FAC). Wall failure in these pipes can result in serious personal injury, property damage and economic harm. Therefore, it is desirable to measure component wall thickness accurately and predict potential wall failures well in advance.

Numerous techniques for measuring wall thicknesses are available, including, for example, ultrasonic thickness (UT) measurement tools. As with all measurement tools, inaccuracies are often present and operator error may introduce additional error into the process. Measurement uncertainties may also originate from manufacturing variations associated with the components. For example, according to manufacturer specifications, some utility pipes can have a 12% variation in their initial thickness.

To complicate things even further, there are often very few data sets (e.g., N=1 or N=2) for statistical analysis. Not only are typical UT systems and tools expensive to purchase and operate, the complexity and accessibility of many industrial processes also makes it difficult to have every component monitored on a regular or periodic basis. As a result, many UT wall thickness measurements produce single-inspection data (N=1) or two sets of data (N=2), for which conventional statistical approaches are not applicable or effective.

With small data population and various types of measurement uncertainties, analysis of thickness data and prediction of wall failure may be a challenging task. Some prior art methods attempt to filter out the measurement uncertainties by focusing on the worst-scenario estimates. For example, an engineer would calculate the fastest wear rate from a set of thickness data, and apply this fastest wear rate to a thinnest spot in the component. As such, the prior art methods often come up with an overly conservative prediction of a component's remaining lifetime. The conservative prediction often cause unnecessary inspection and maintenance jobs to be performed, resulting in significant expenses that should have been avoided.

Electric Power Research Institute (EPRI) developed CHECWORKS, an integrated software for corrosion control in plant piping and in-line equipment. Though CHECWORKS is valuable in planning inspections to prevent failure, evaluating mitigation options, and developing new designs to reduce the probability of piping degradation in power plants, it is incapable of providing accurate prediction for wall failures based on small population thickness data.

In view of the foregoing, it would be desirable to provide a technique for wall thickness data analysis which overcomes the above-described inadequacies and shortcomings.

### SUMMARY OF THE DISCLOSURE

A technique for wall thickness data analysis is disclosed. In one particular exemplary embodiment, the technique may be realized as a method for wall thickness analysis. The method may comprise providing a plurality of thickness data for a plurality of locations on the component, wherein one or more thickness data measured at specified times are provided for each location. The method may also comprise partitioning the plurality of thickness data into subsets that correspond to one or more portions of the component. The method may further comprise determining, for a first location associated with a first portion of the component, a first wear rate according to a statistical method selected based on the number of thickness data available for the first location.

In another particular exemplary embodiment, the technique may be realized by at least one signal embodied in at least one carrier wave for transmitting a computer program of instructions configured to be readable by at least one processor for instructing the at least one processor to execute a computer process for performing the method as recited above.

In yet another particular exemplary embodiment, the technique may be realized by at least one processor readable carrier for storing a computer program of instructions configured to be readable by at least one processor for instructing the at least one processor to execute a computer process for performing the method as recited above.

In still another particular exemplary embodiment, the technique may be realized by a wall thickness data analyzer. The wall thickness data analyzer may comprise a storage device that stores a plurality of thickness data for a plurality of locations on the component, wherein one or more thickness data measured at specified times are provided for each location. The wall thickness data analyzer may also comprise a processor operable to access the storage device and to perform the following: partitioning the plurality of thickness data into subsets that correspond to one or more portions of the component, and determining, for a first location associated with a first portion of the component, a first wear rate according to a statistical method selected based on the number of thickness data available for the first location.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be exemplary only.

FIGS. 1-4 are a series of photographs of various components illustrating exemplary grids on the outer surface of the components in accordance with an embodiment of the present disclosure.

FIG. 5 is a flow chart illustrating an exemplary method for analyzing wall thickness of a component in accordance with an embodiment of the present disclosure.

FIG. 6 is a block diagram illustrating an exemplary system for analyzing wall thickness of a component in accordance with an embodiment of the present disclosure.

FIGS. 7.1-7.44 illustrate a series of exemplary worksheets for wall thickness data analysis in accordance with an embodiment of the present disclosure.

FIG. 8 illustrates an exemplary method for determining a remaining lifetime for a grid location in accordance with an embodiment of the present disclosure.

### DETAILED DESCRIPTION OF EXEMPLARY EMBODIMENTS

As stated above, conventional statistical approaches cannot be used to analyze UT wall thickness measurements from single-inspection data (N=1) or even from two sets of data (N=2) because there are too few “degrees of freedom” to determine standard deviation. For example, for a particular spot in a component inspected, wall thickness data may have been measured one or two times. According to embodiments of the present disclosure, such a lack of data population may be remedied by taking multiple measurements at substantially the same time and at a plurality of locations on the component. The plurality of locations may be defined by a grid or matrix pattern.

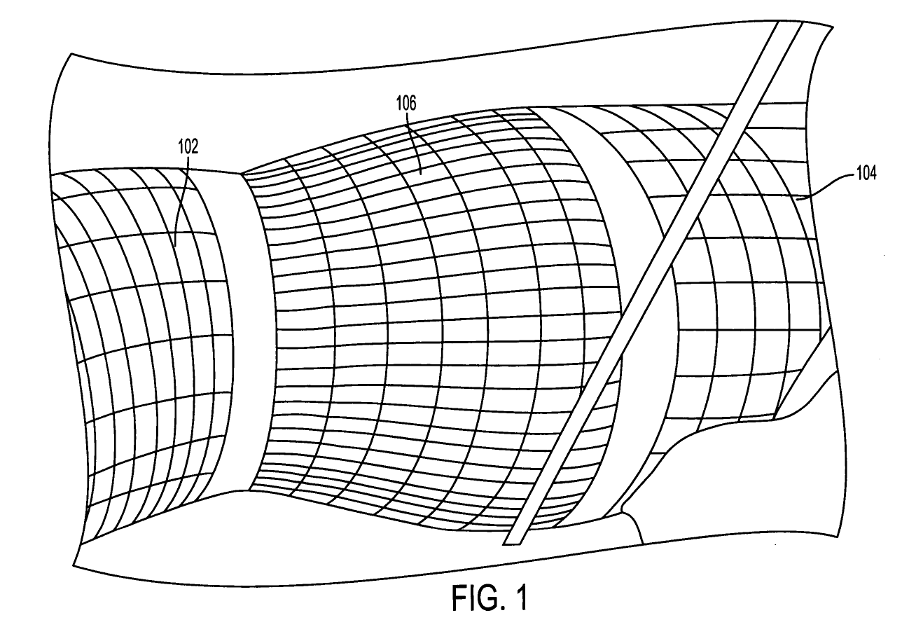

In FIGS. 1-4, there are shown a series of photographs of various components illustrating exemplary grids or matrix patterns on the outer surface of the components to identify locations for taking wall thickness measurements. The spacing of these grids may be calculated or determined based on standards provided by technical organizations such as the American Society of Mechanical Engineers (ASME). According to one embodiment, in order to maintain confidence level for the measurement data, the grid spacing may be chosen to be no larger than 2\sqrt{Rt}, where R is an effective radius of the component and t is a nominal thickness of the component wall.

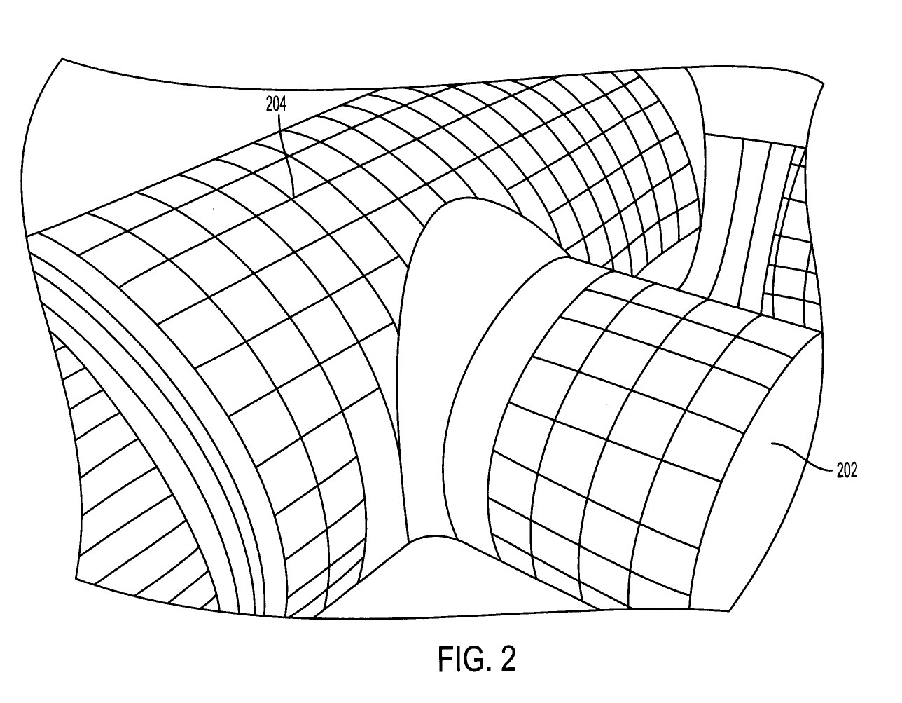

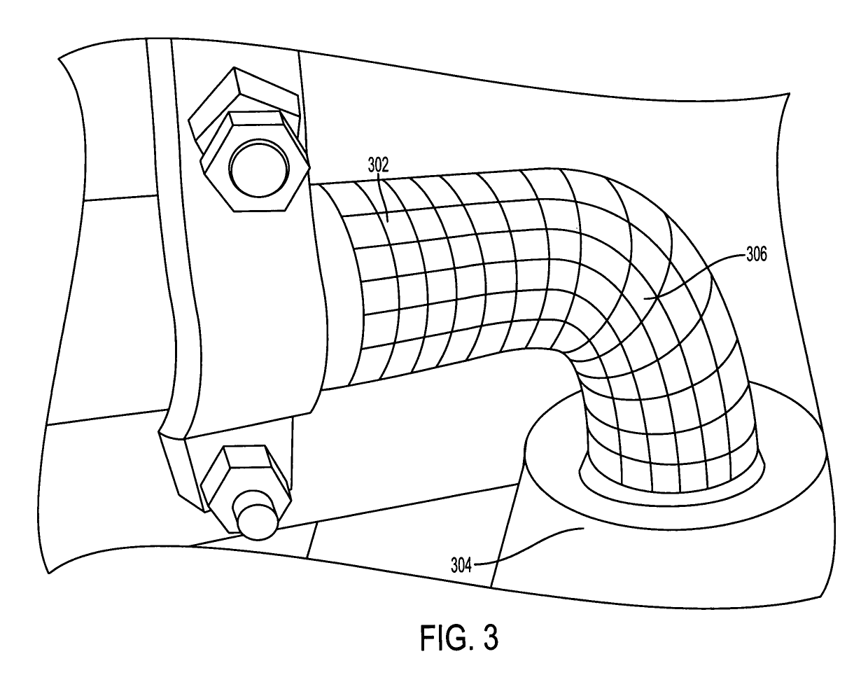

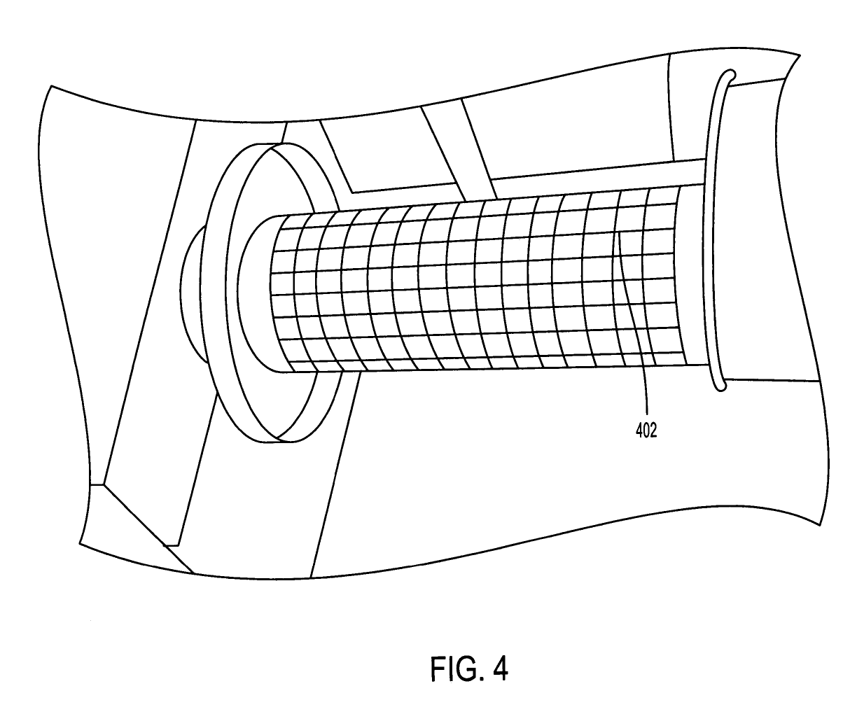

As shown in FIGS. 1-4, a grid or matrix may be adapted to all kinds of component configurations, and one component may comprise one or more pipes, vessels and/or joining devices. For example, in FIG. 1, two pipes (102 and 104) of different radii are joined together by a reducer 106. FIG. 2 shows a T-junction where one pipe 202 has its end joined to the side of another pipe 204. FIG. 3 shows the ends of two perpendicularly positioned pipes 302 and 304 being joined by an elbow pipe 306. And FIG. 4 shows a straight cylindrical pipe 402. In each configuration, one or more grids may be established with row lines and column lines on the outer surface of the component, with different portions of the component being accommodated by different grid spacing. For instance, in FIG. 1, the row spacing for the narrower pipe 102 is smaller than the row spacing for the thicker pipe 104.

Generally, a wall thickness measurement may be taken at the intersection of each row and column of the grid or matrix. By maintaining these grids on the component, measurements may be repeated over time at the same locations to determine if wall thickness is deteriorating or to determine the rate of such wall thickness deterioration. In one embodiment as will be described in detail below, the rows may be defined to extend around the periphery of the component, e.g., circumferentially around a pipe, and the columns may extend orthogonally, longitudinally or at an angle to the row and on the component or pipe. However, it should be appreciated that other grid configurations (e.g., hexagonal grids or triangular ones) may also be used.

With multiple measurements at substantially the same time and at a plurality of locations on the component, even a single inspection of the component may produce a large enough data set from which statistical properties applicable to individual data points may be derived. For example, although only one or two thickness data have been measured for a particular location in a particular portion of the component, the variability or uncertainty values derived from those thickness data in or near the same portion may be relied upon to evaluate credibility of the one or two thickness data. Accordingly, embodiments of the present disclosure seek to perform statistical analysis on wall thickness data for a plurality of locations on a component, combining the above-described methodology for single-inspection data points with conventional statistical approaches. Not only may wall thickness loss and wear rates be calculated, such data may be evaluated for their uncertainty and credibility, for example. The output may be a graphical display of wall thickness and/or wear rate data for the plurality of locations, and may be color-coded according to credibility and inspection urgency. Rather than a worst-case estimate, the analysis may further predict next inspection date(s) with specified confidence level.

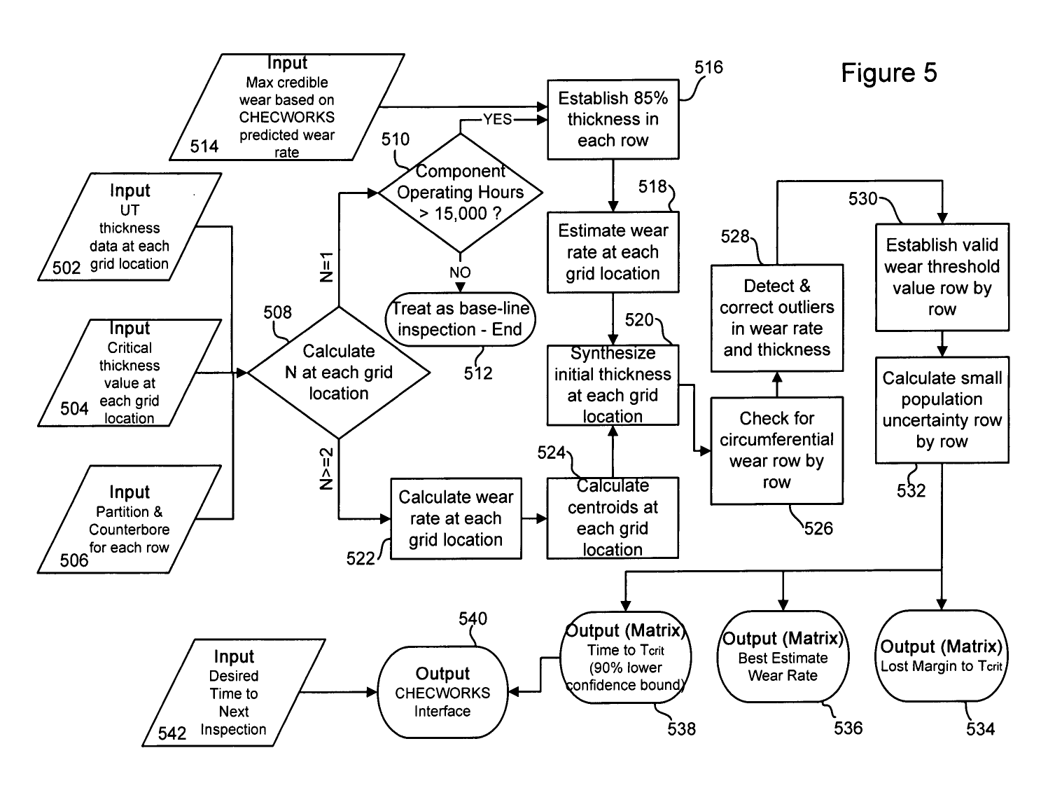

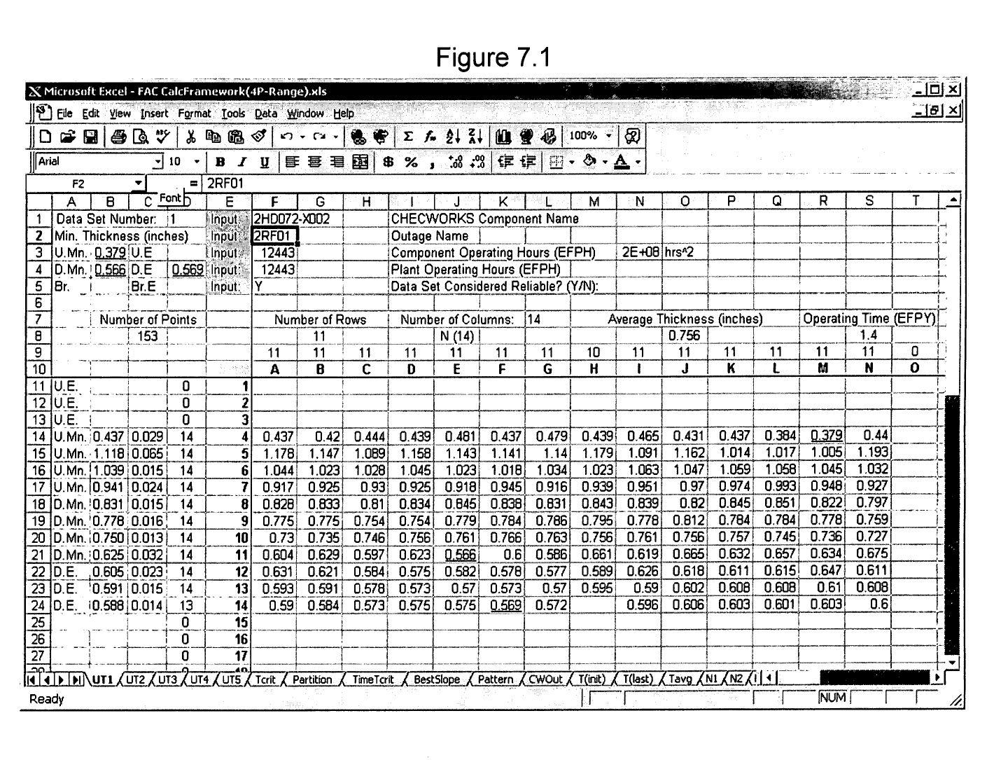

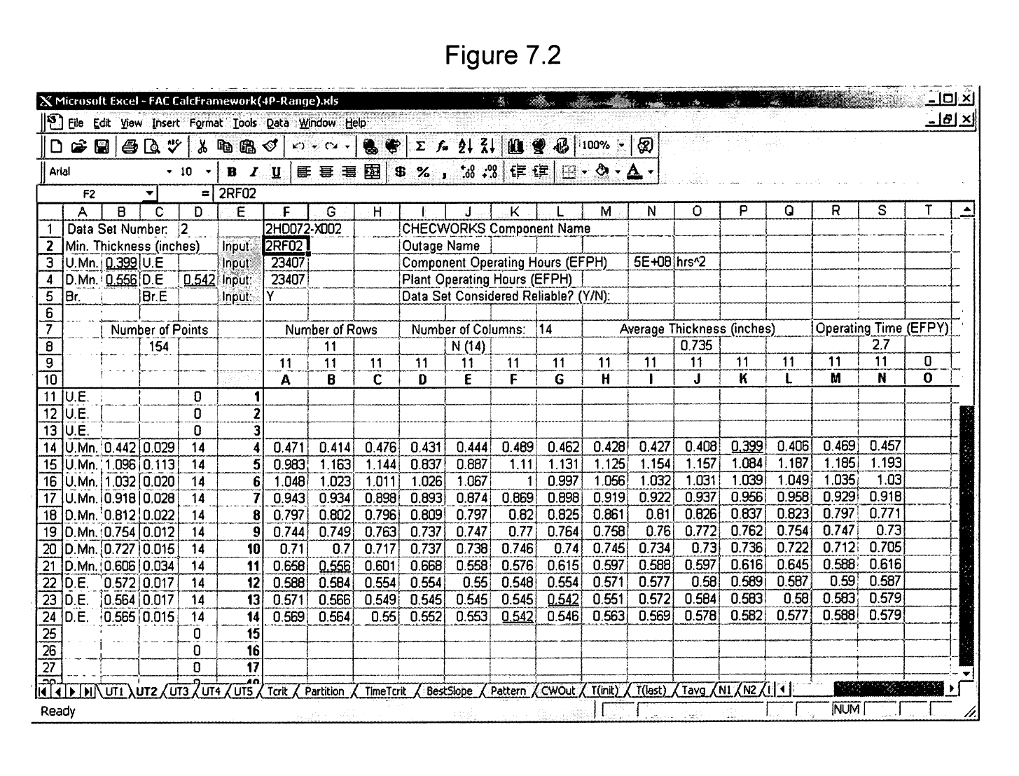

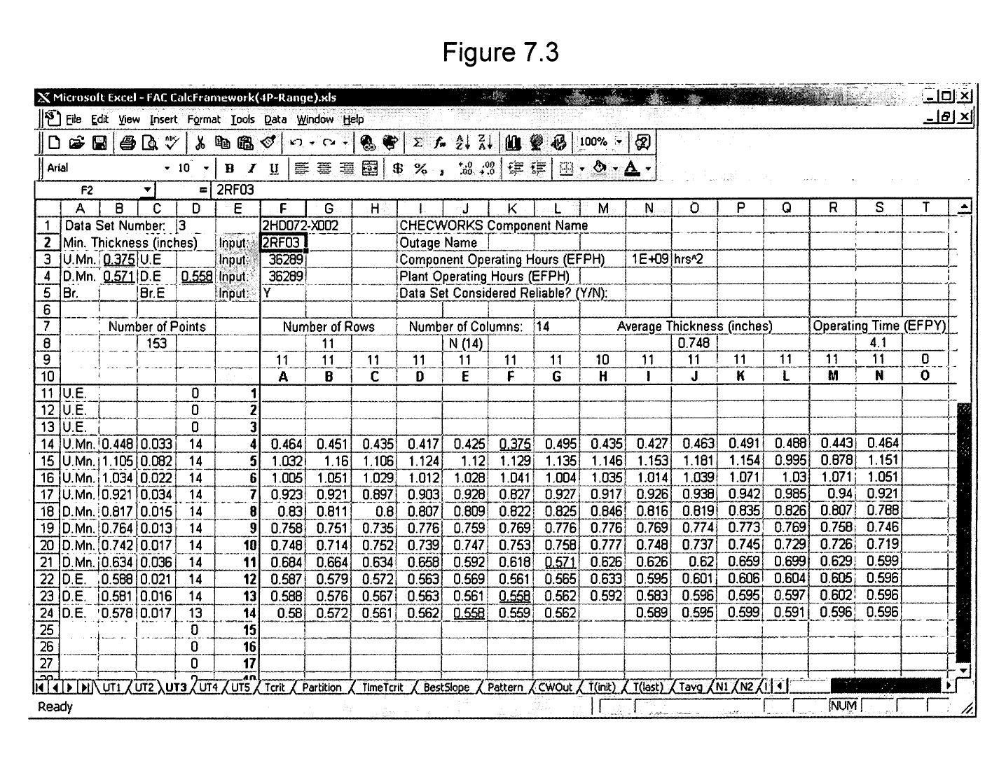

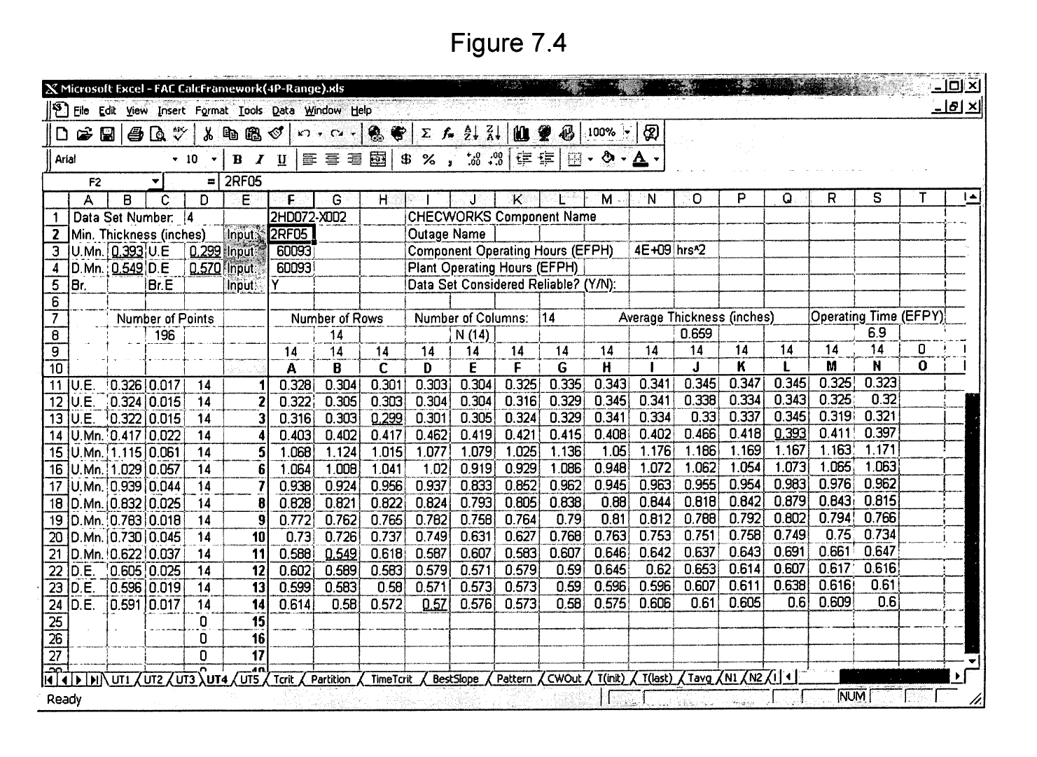

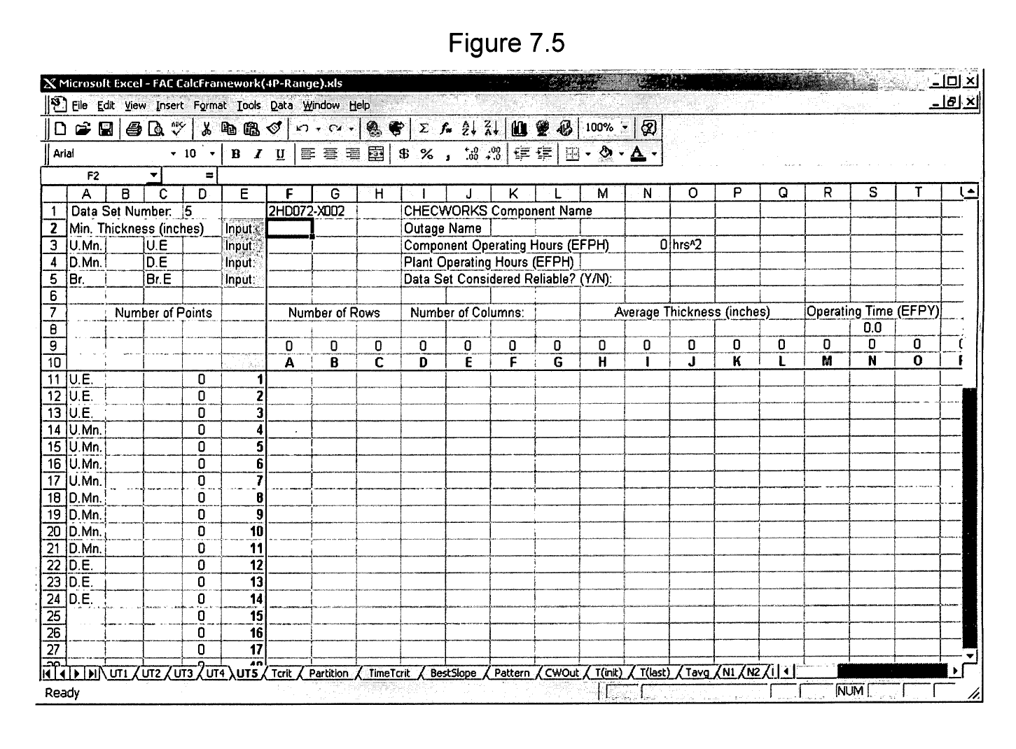

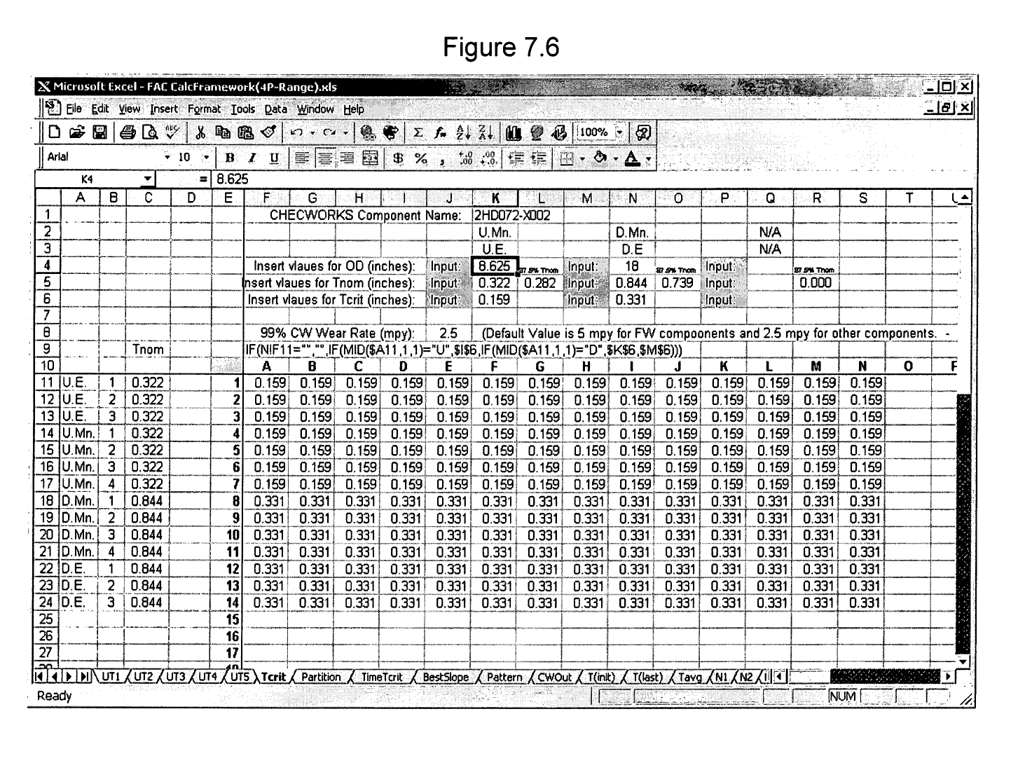

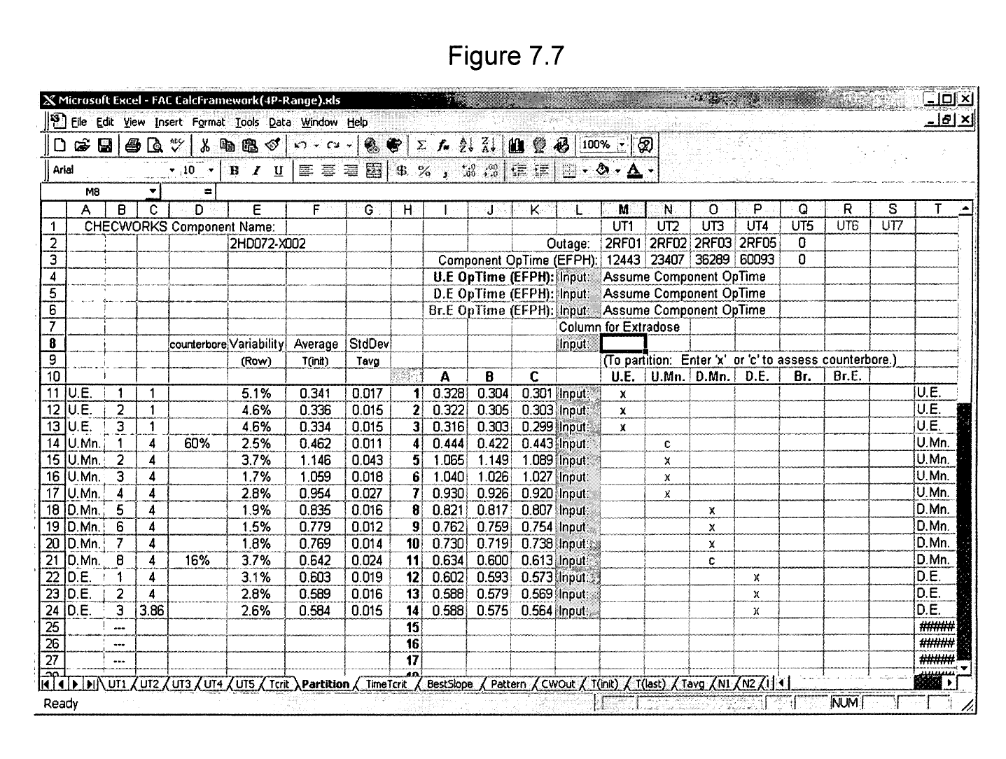

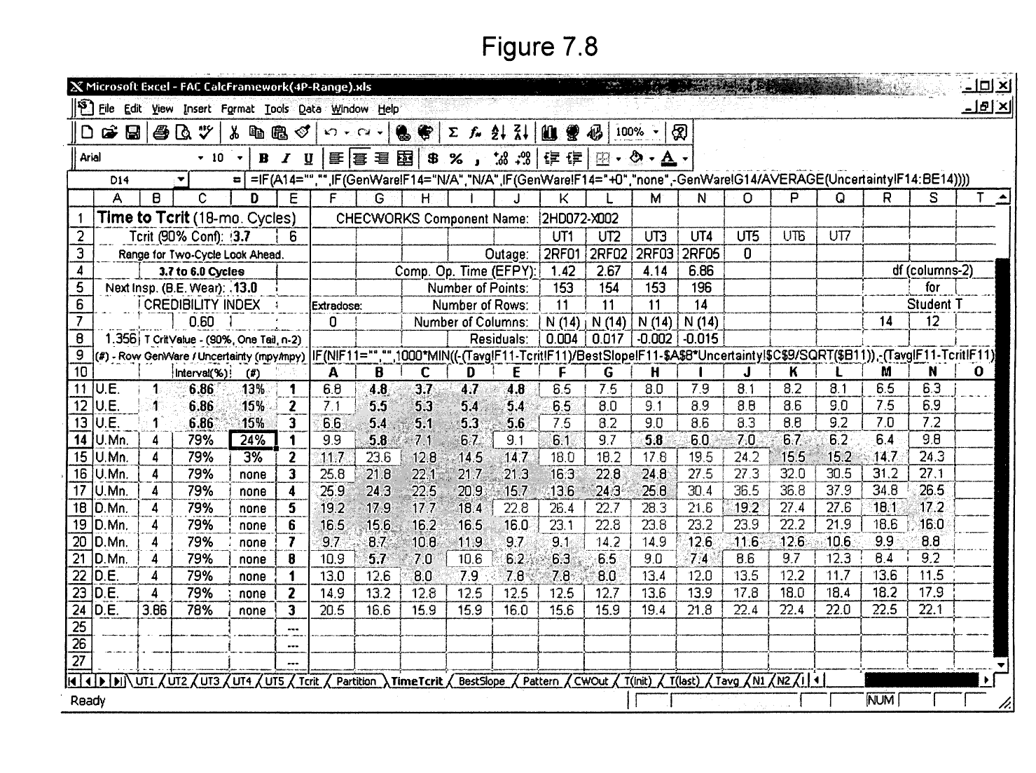

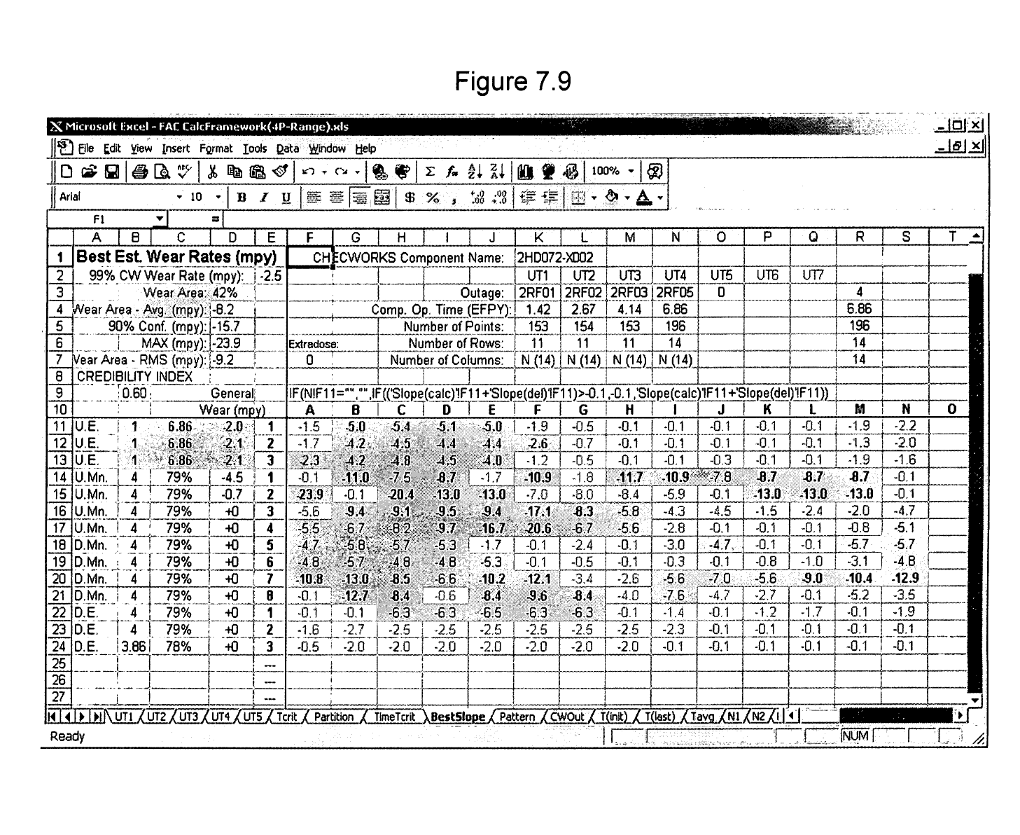

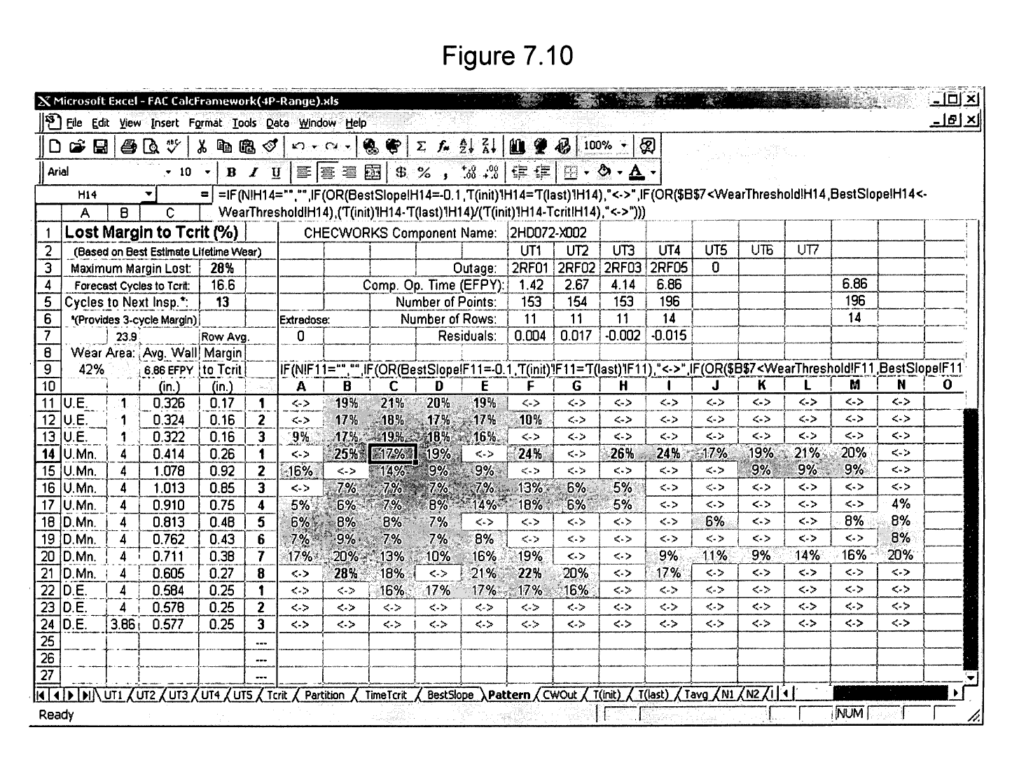

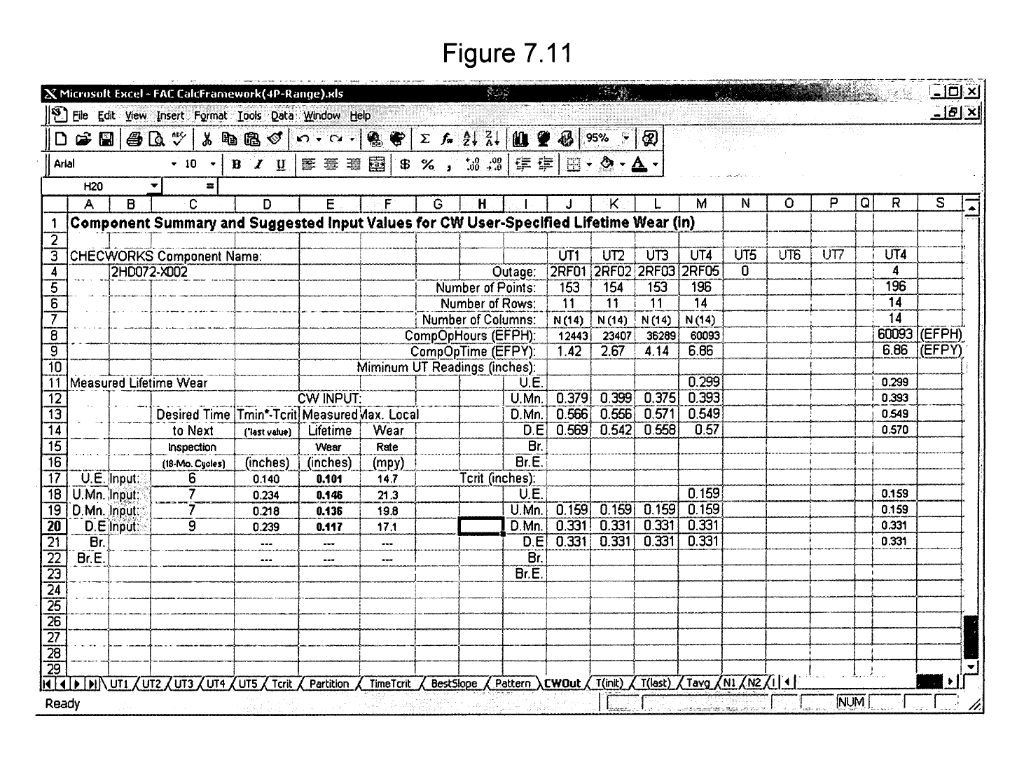

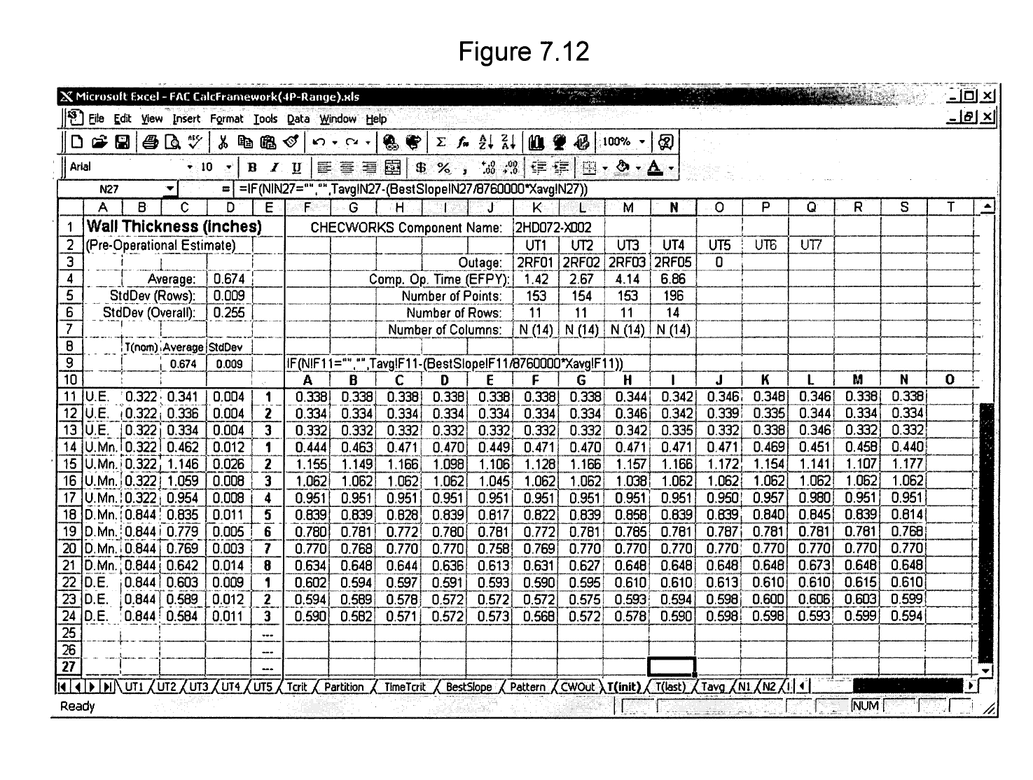

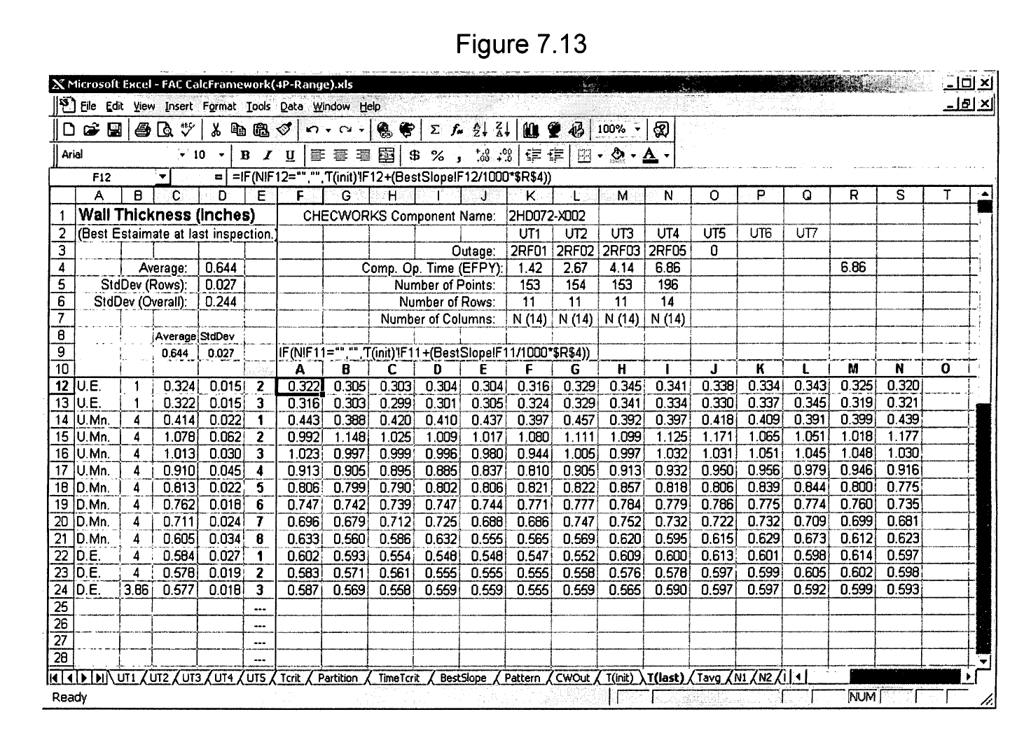

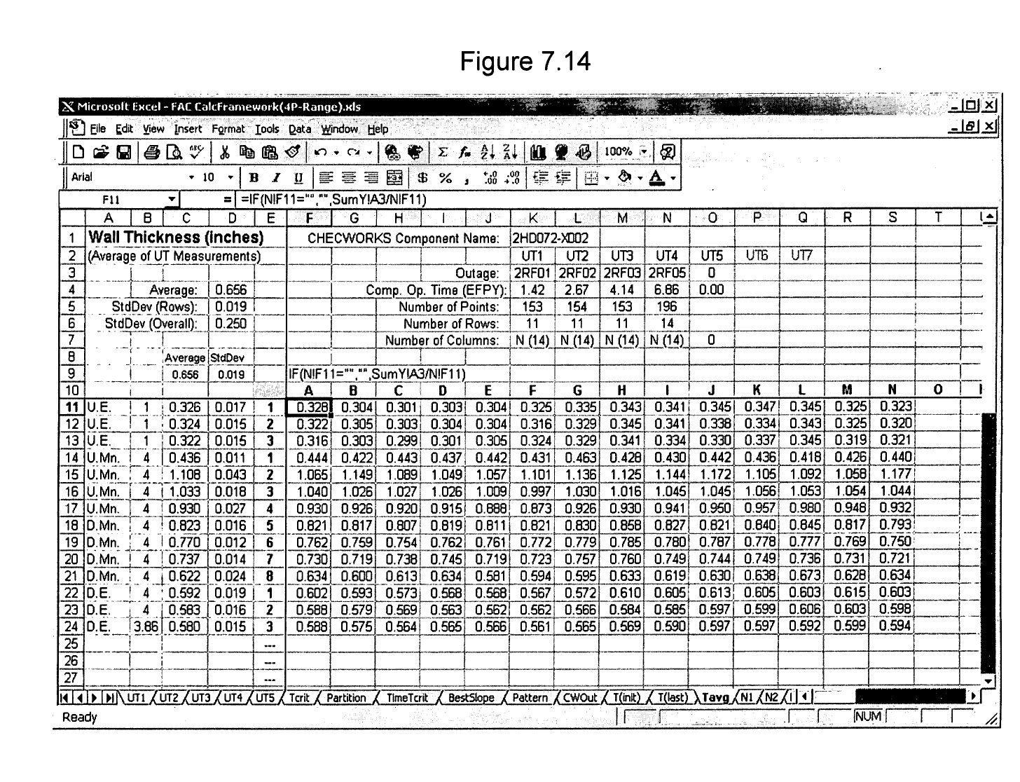

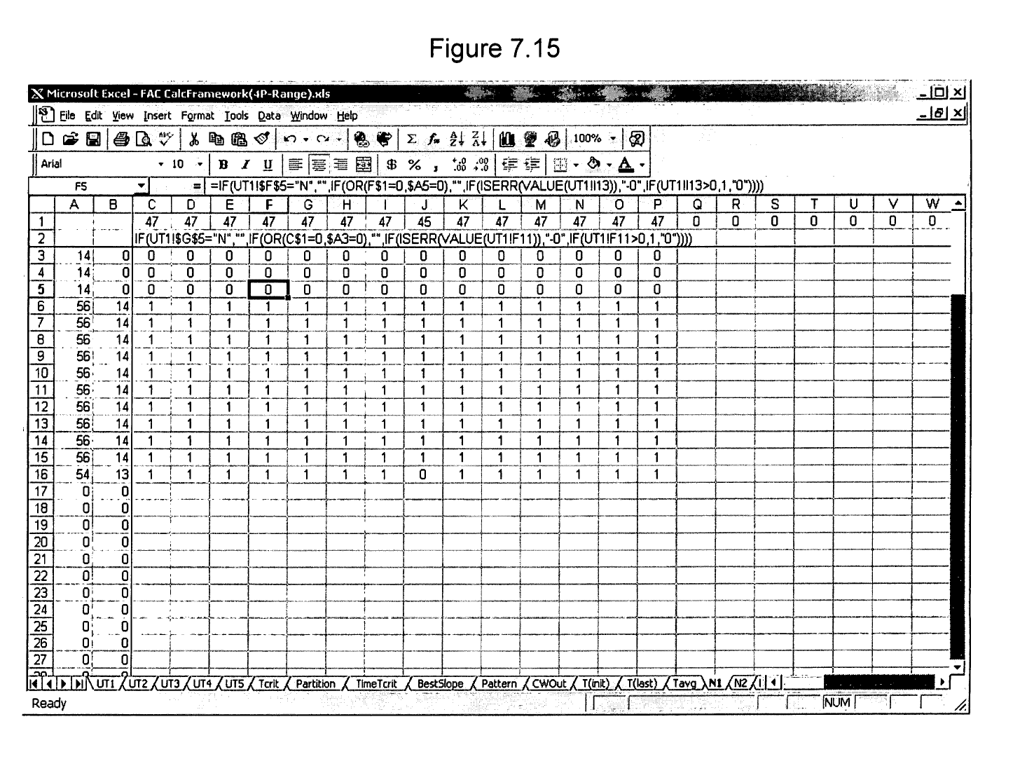

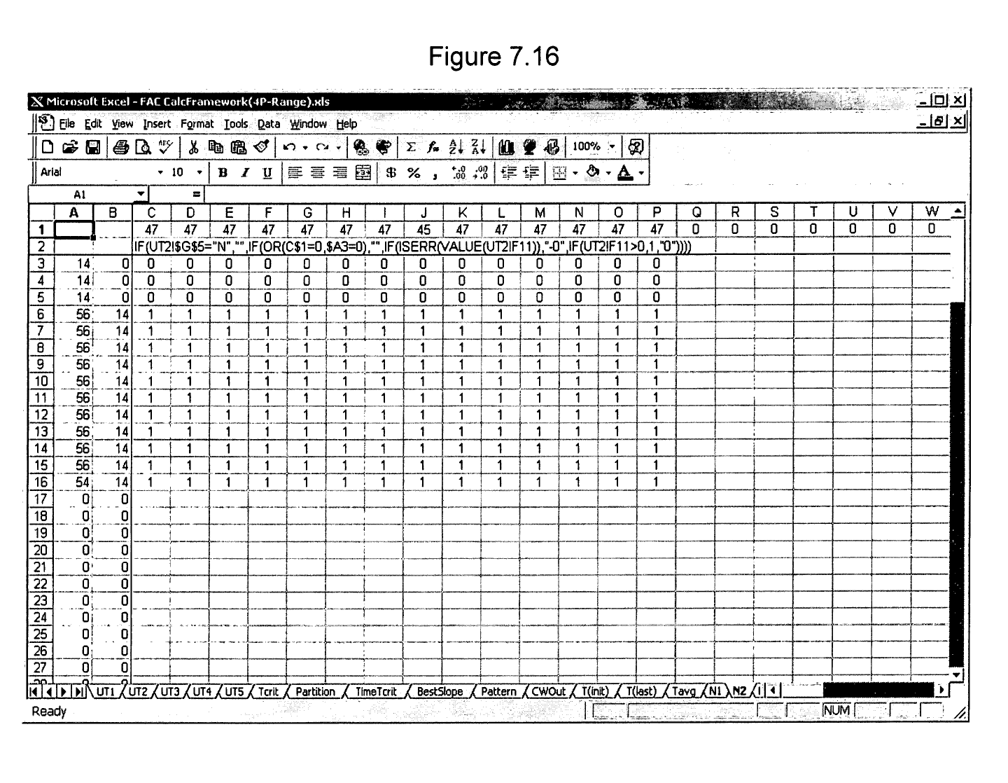

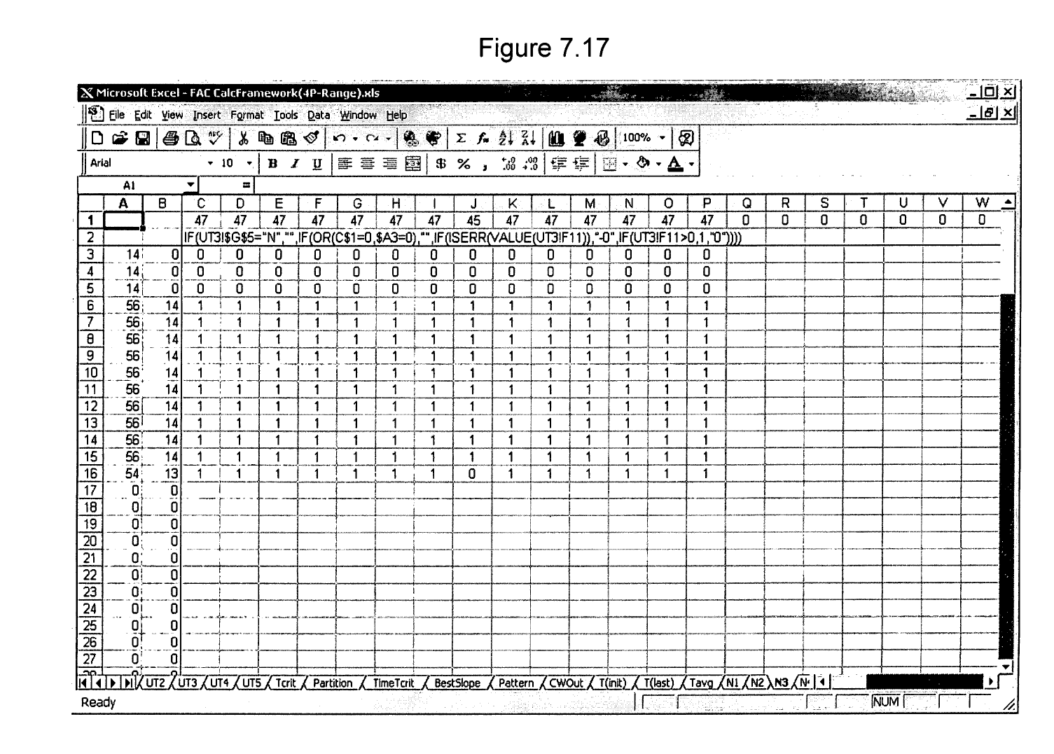

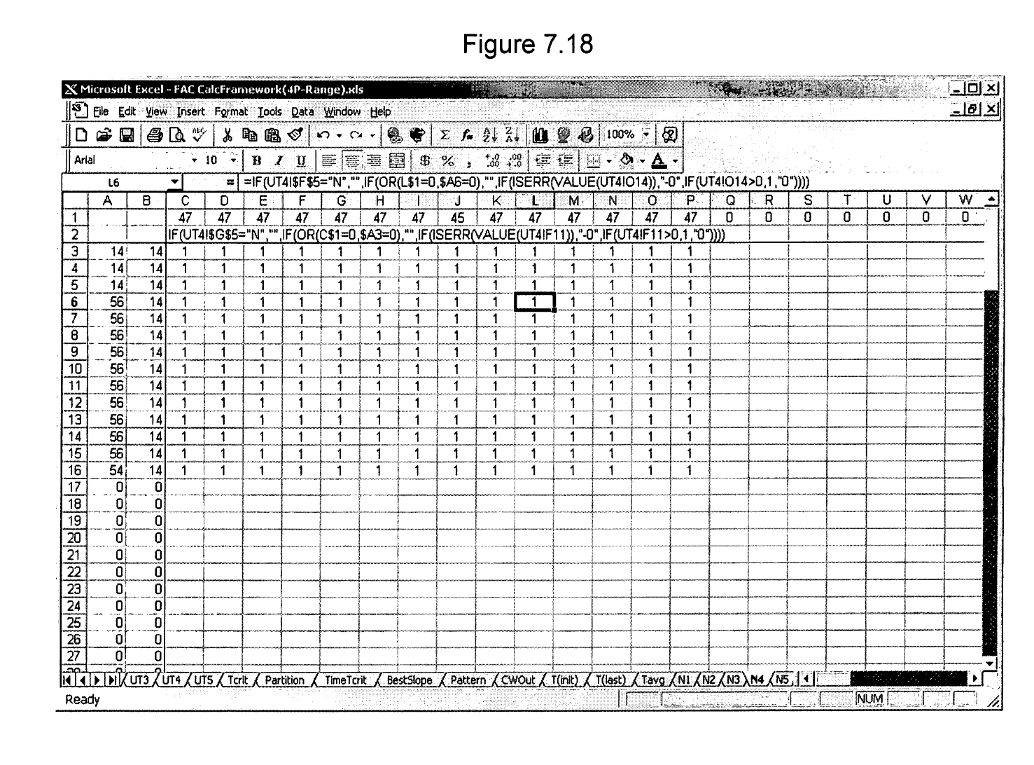

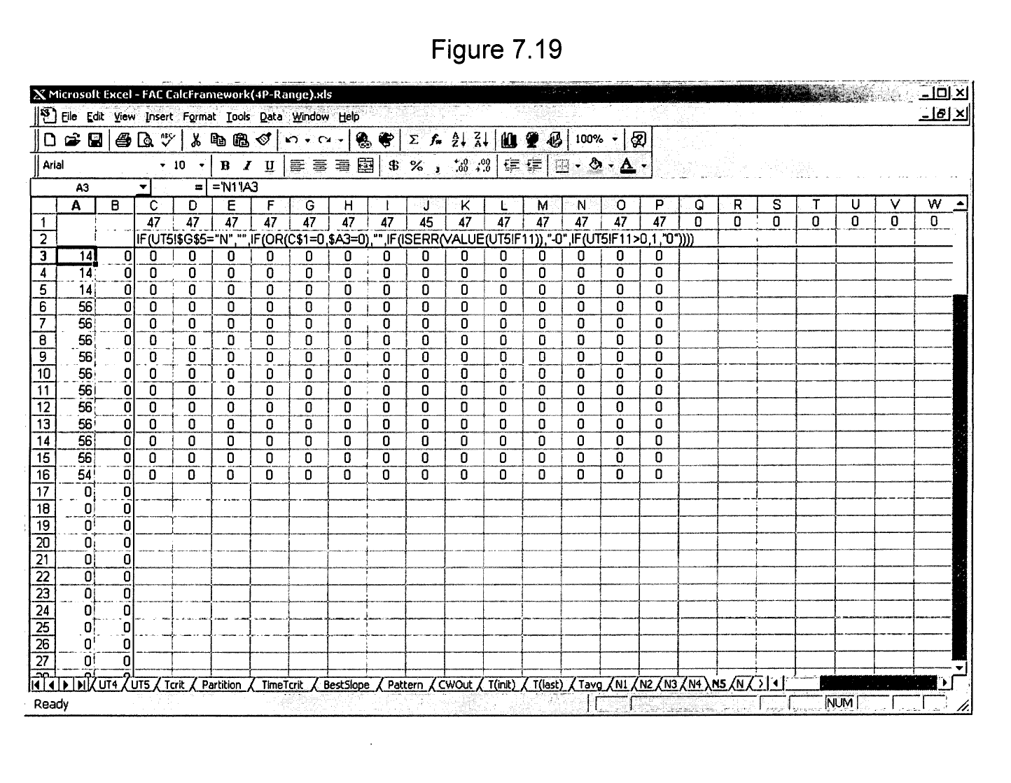

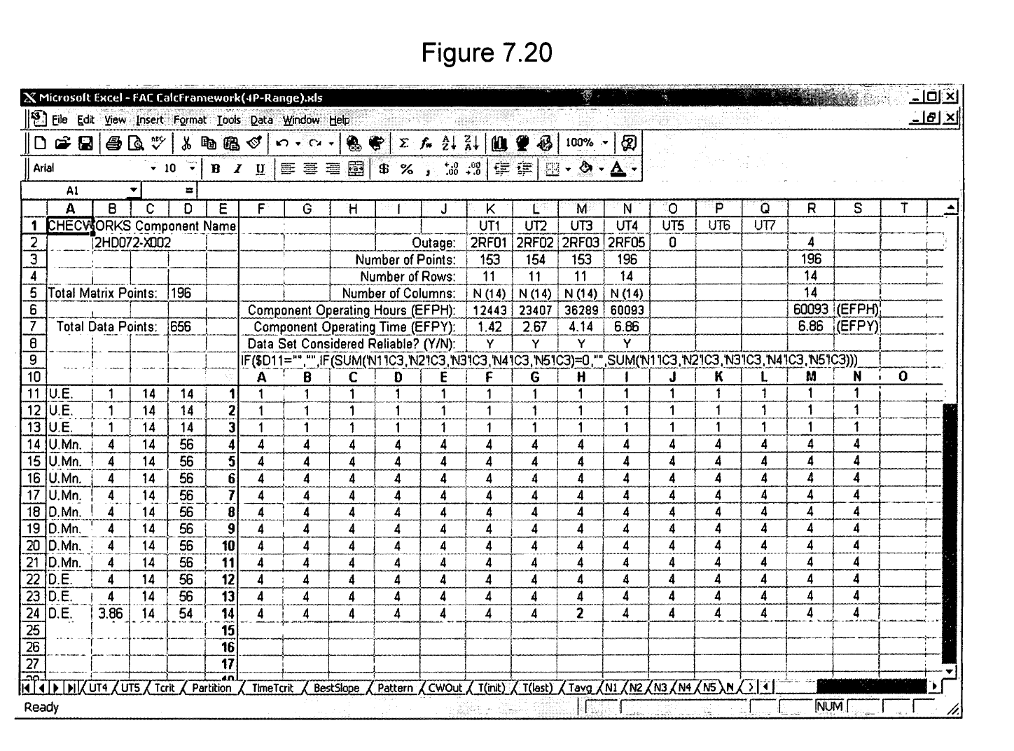

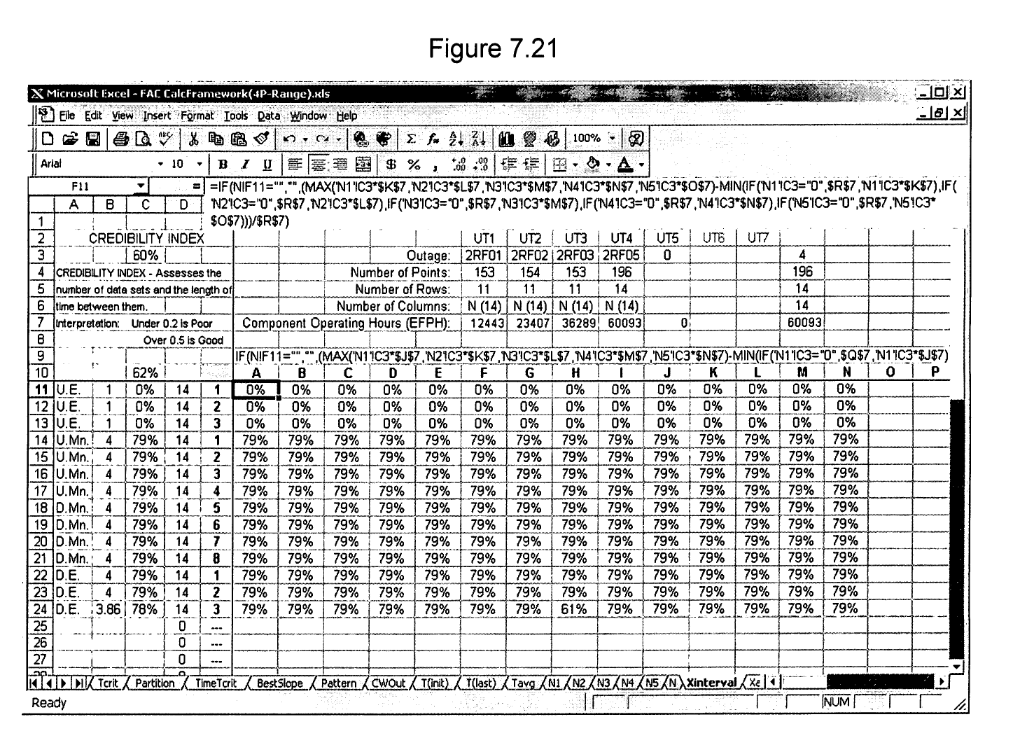

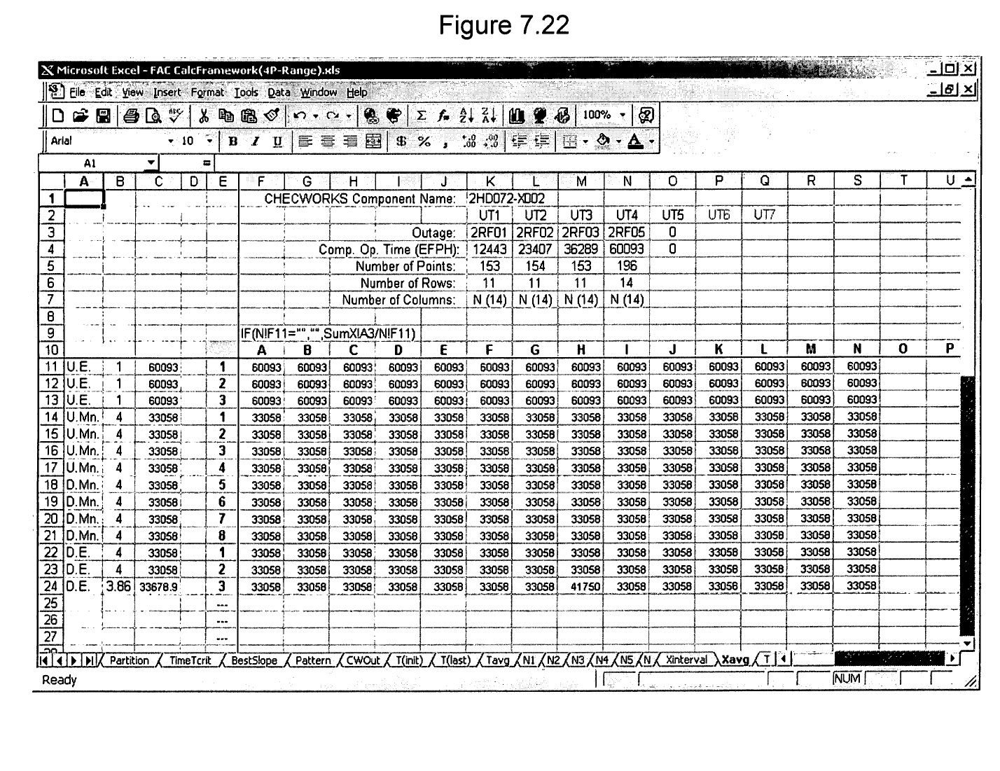

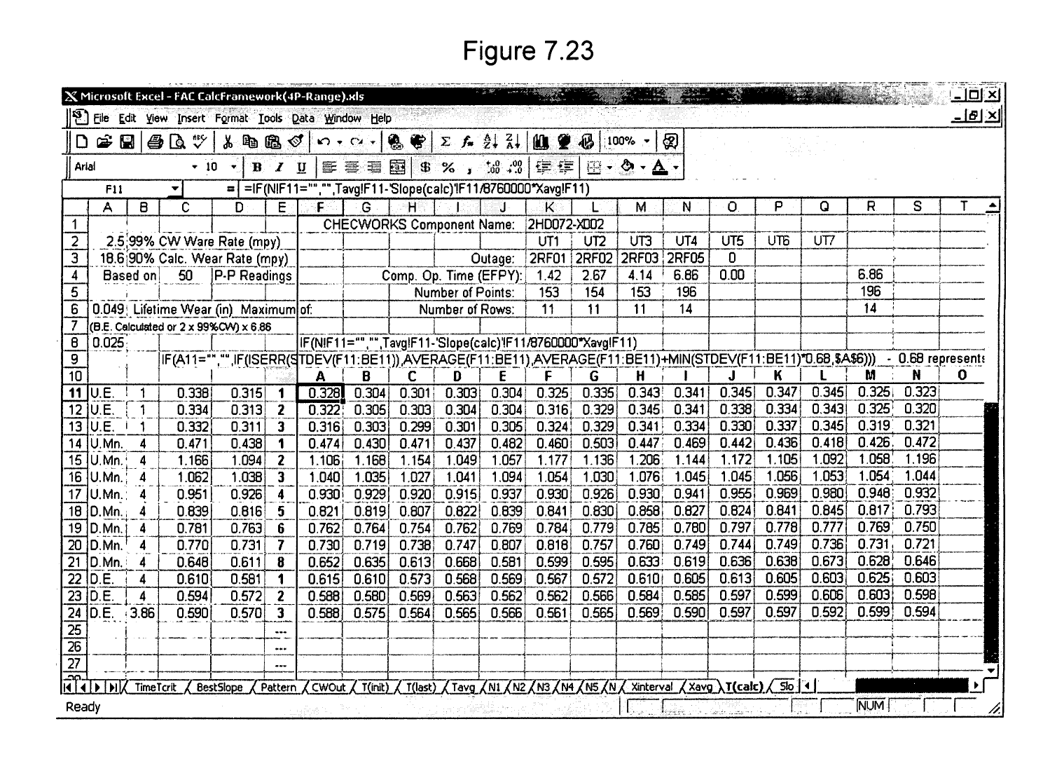

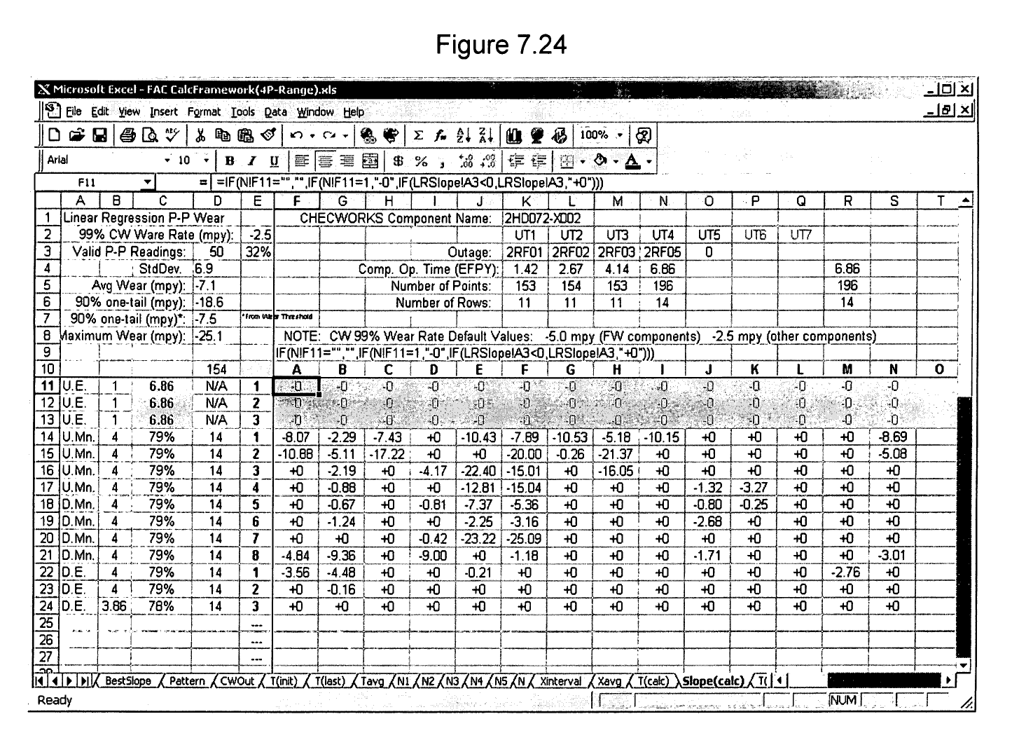

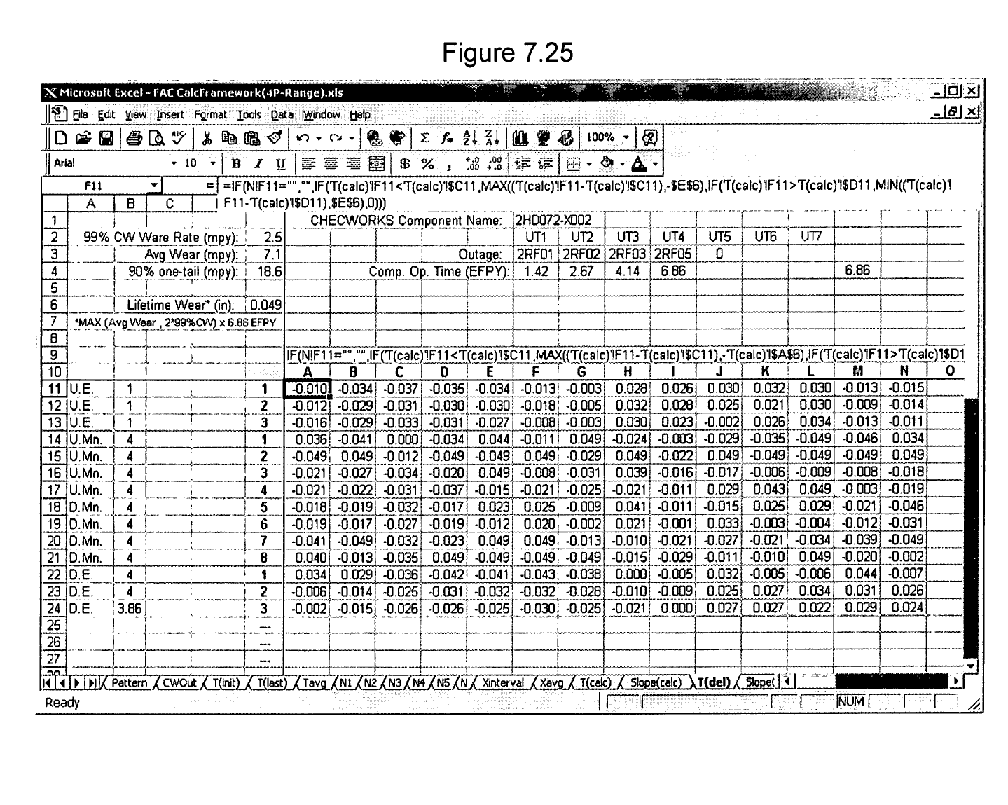

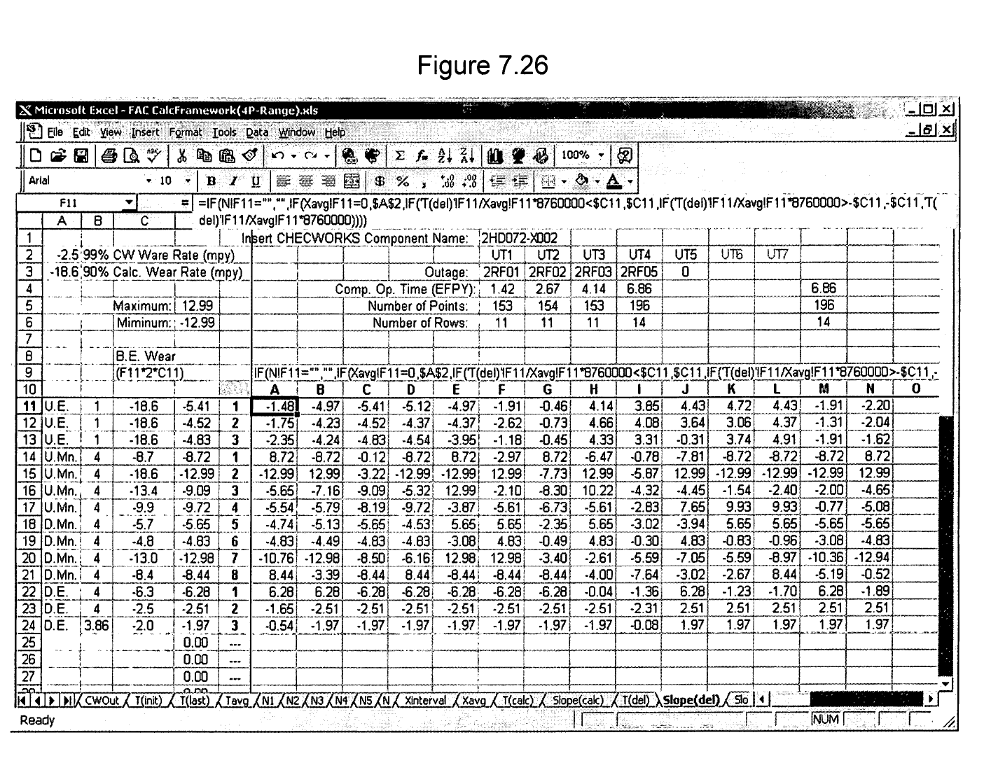

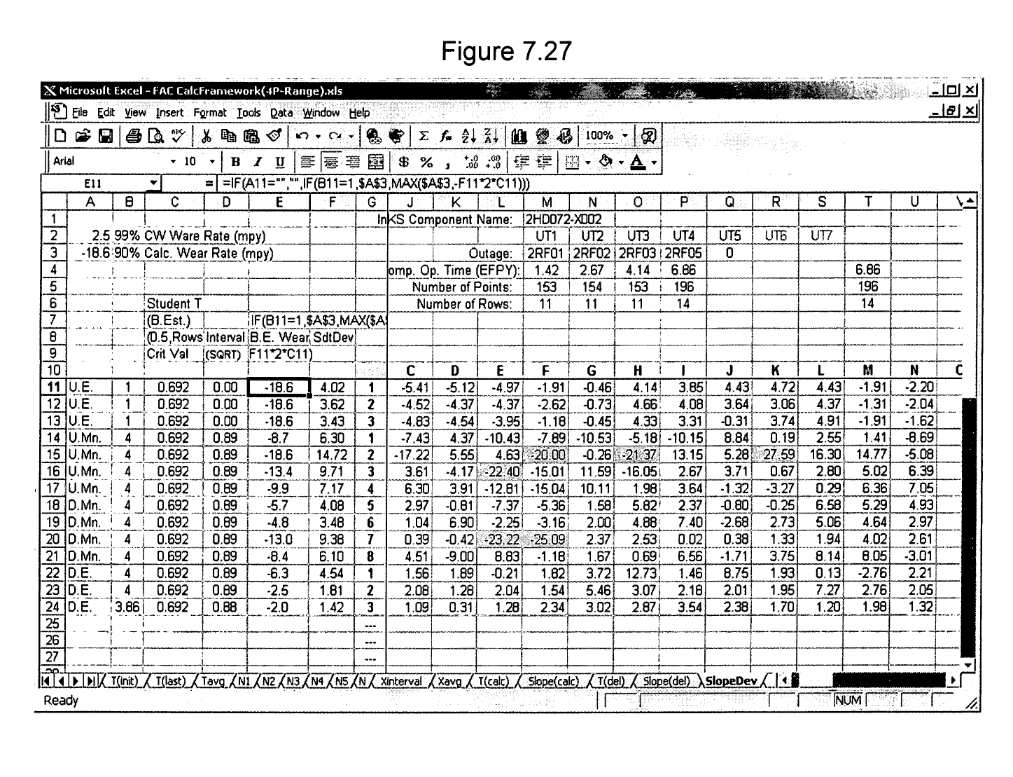

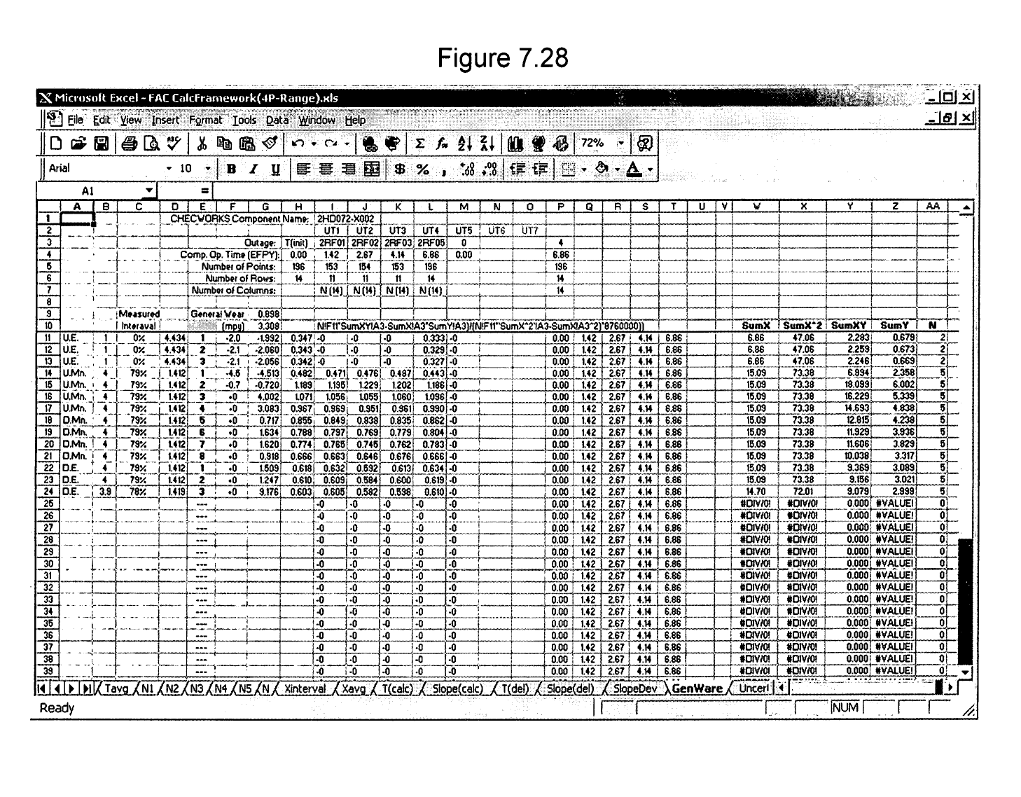

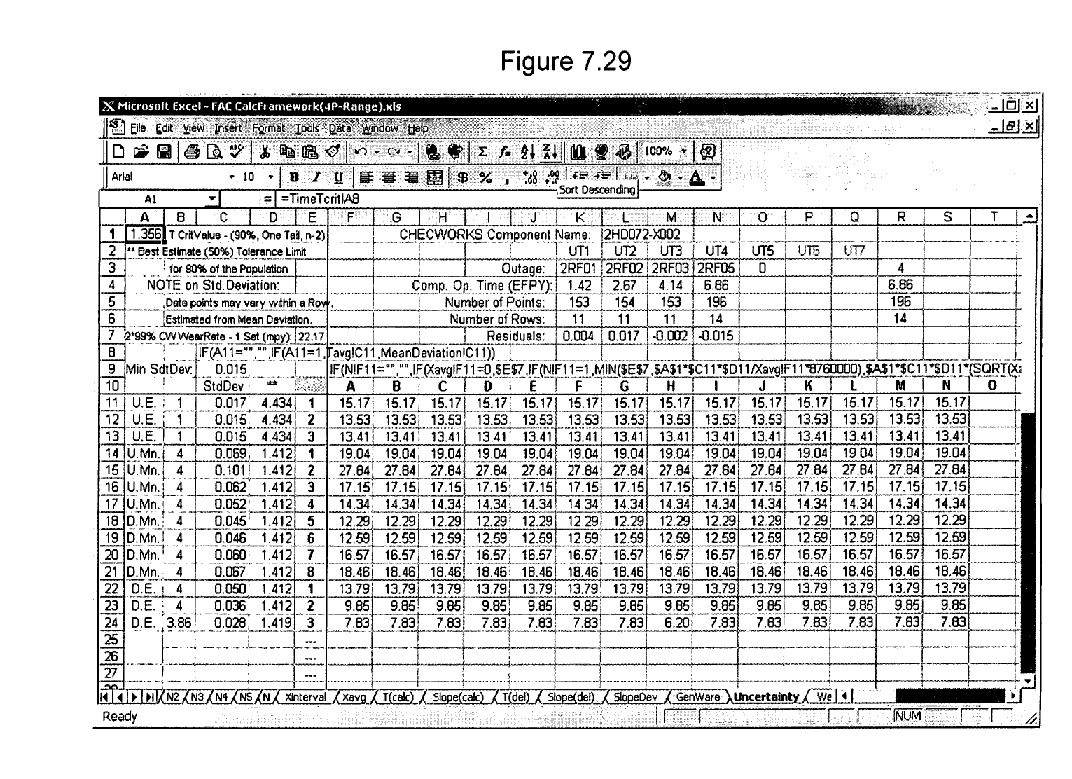

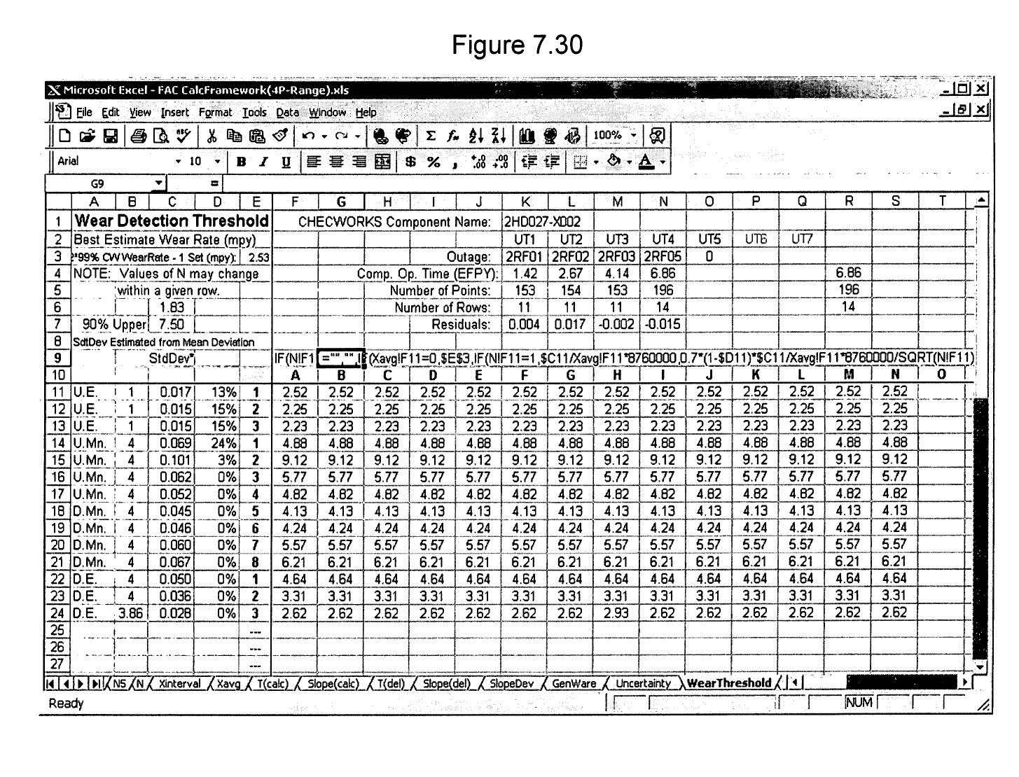

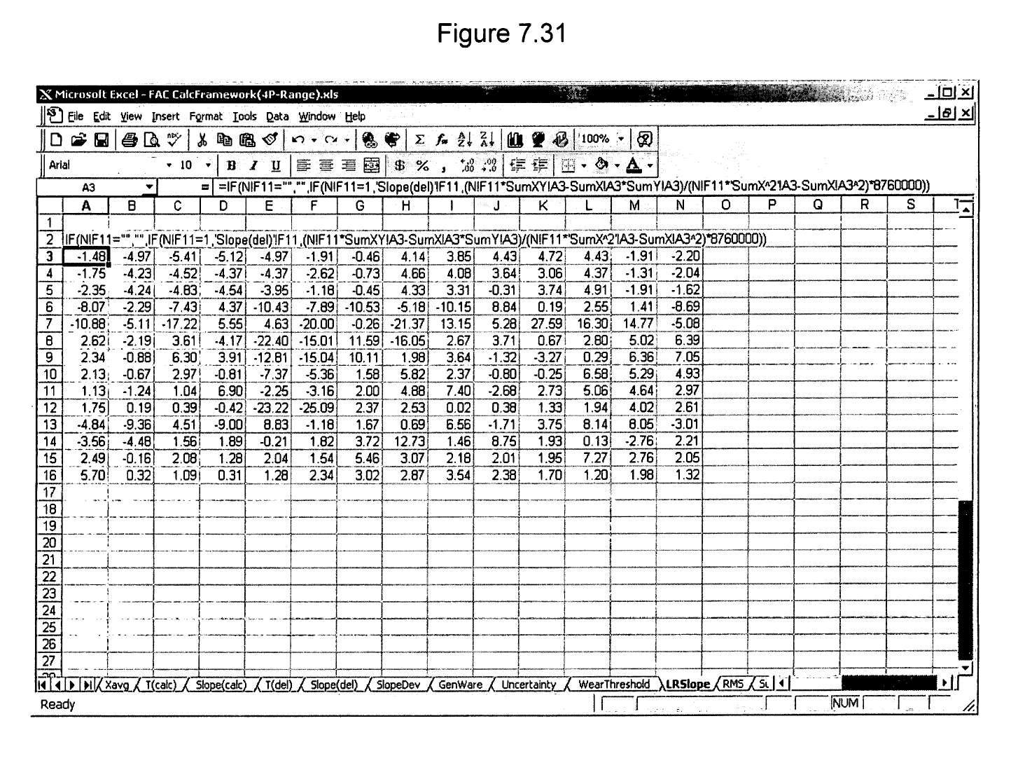

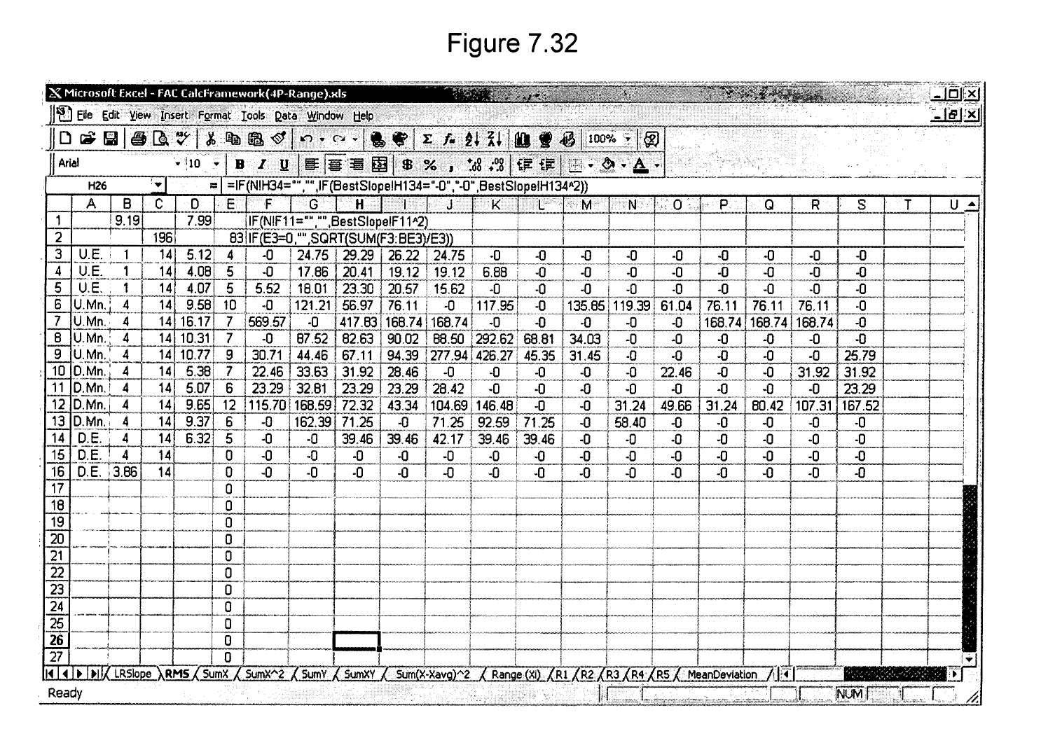

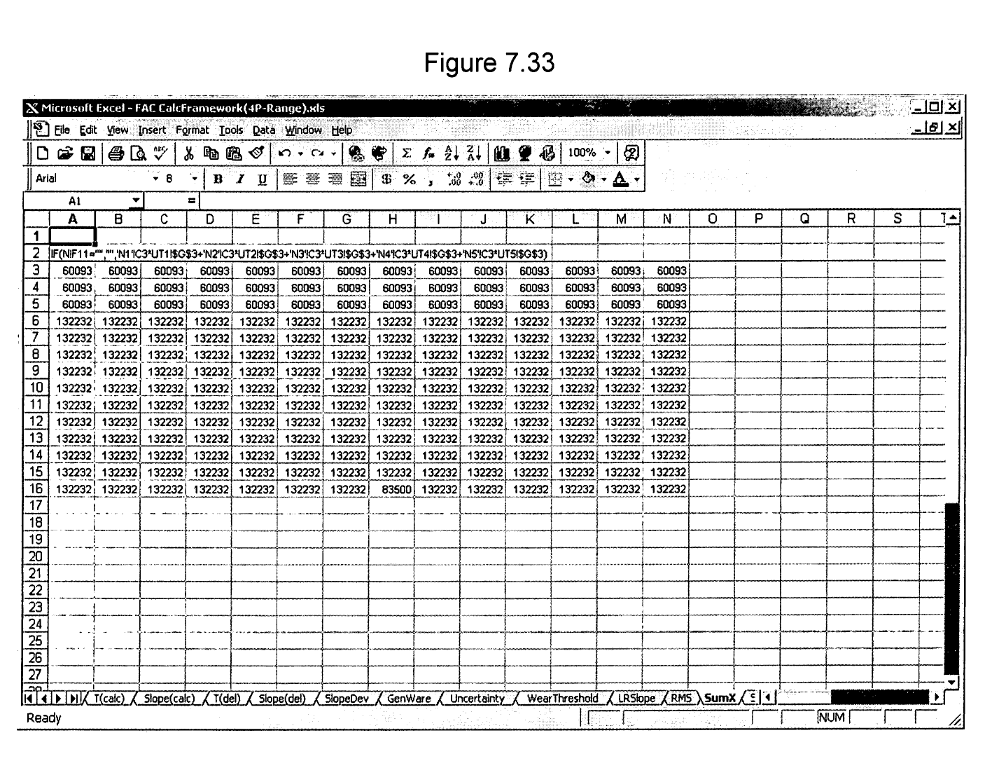

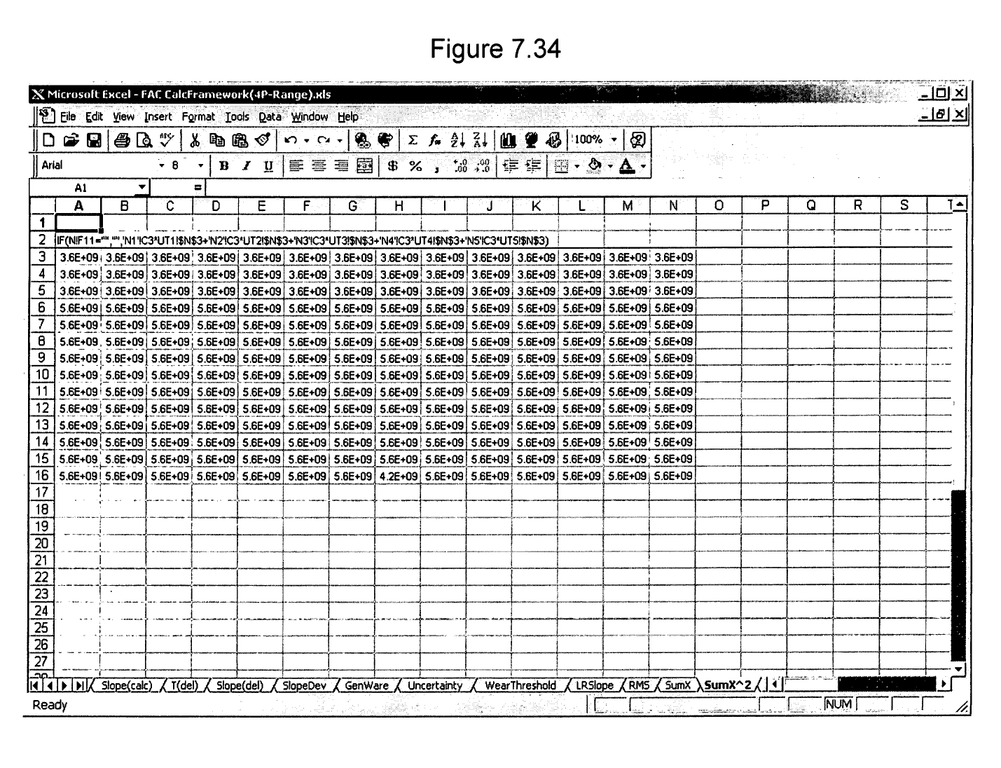

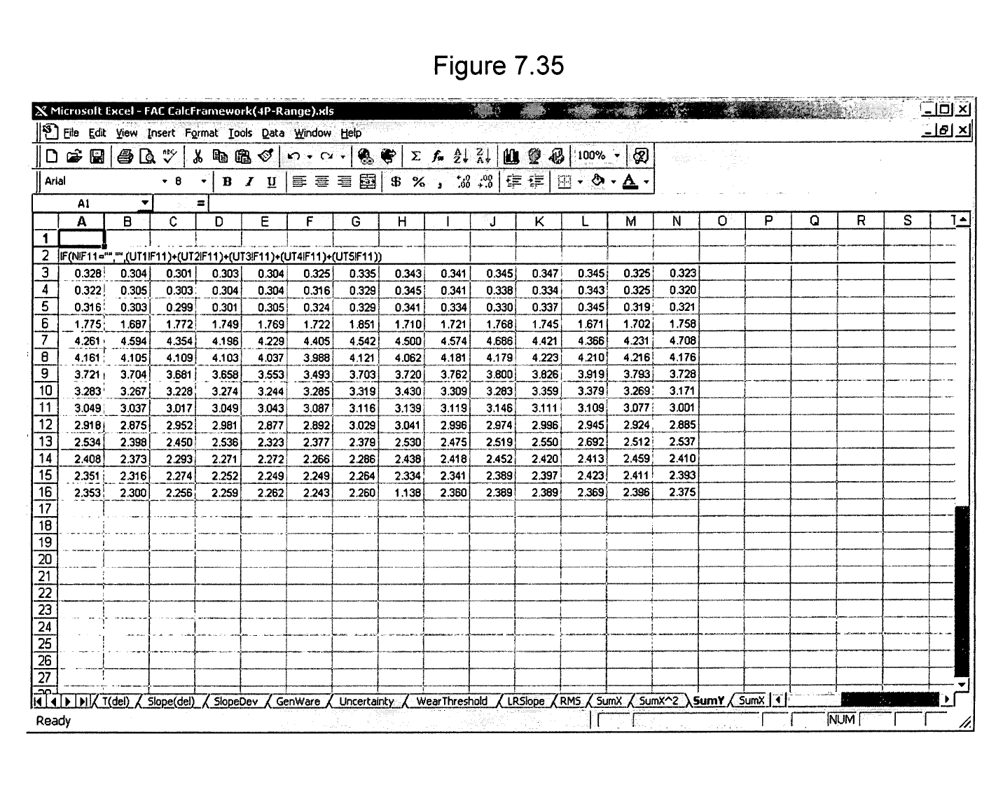

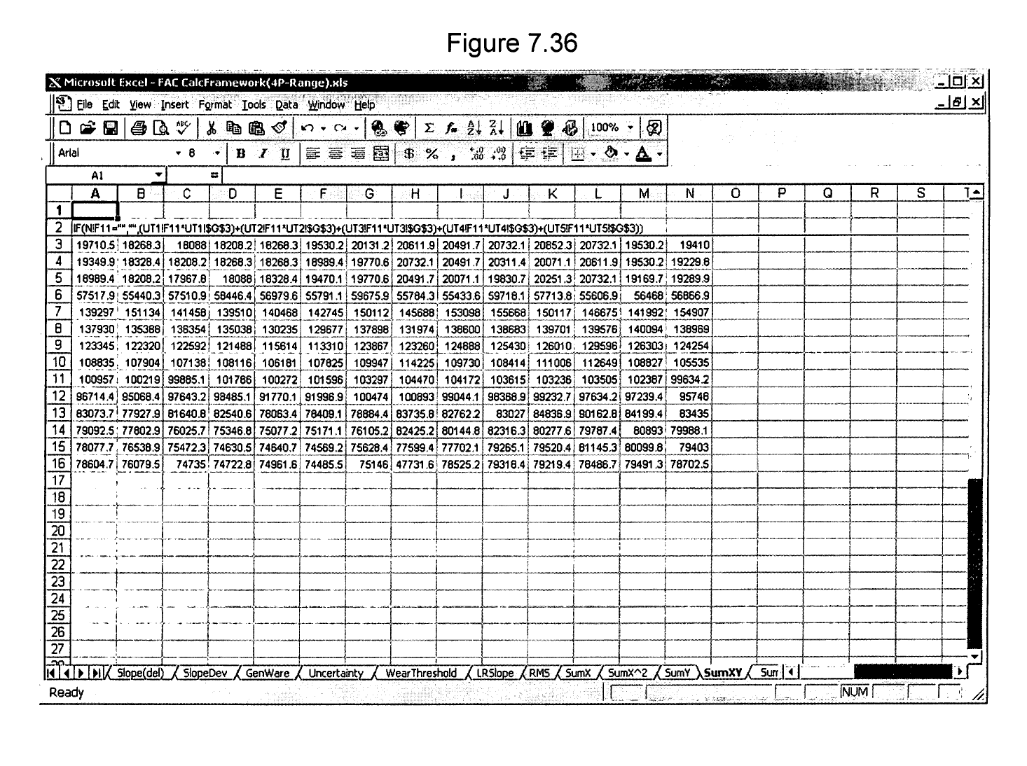

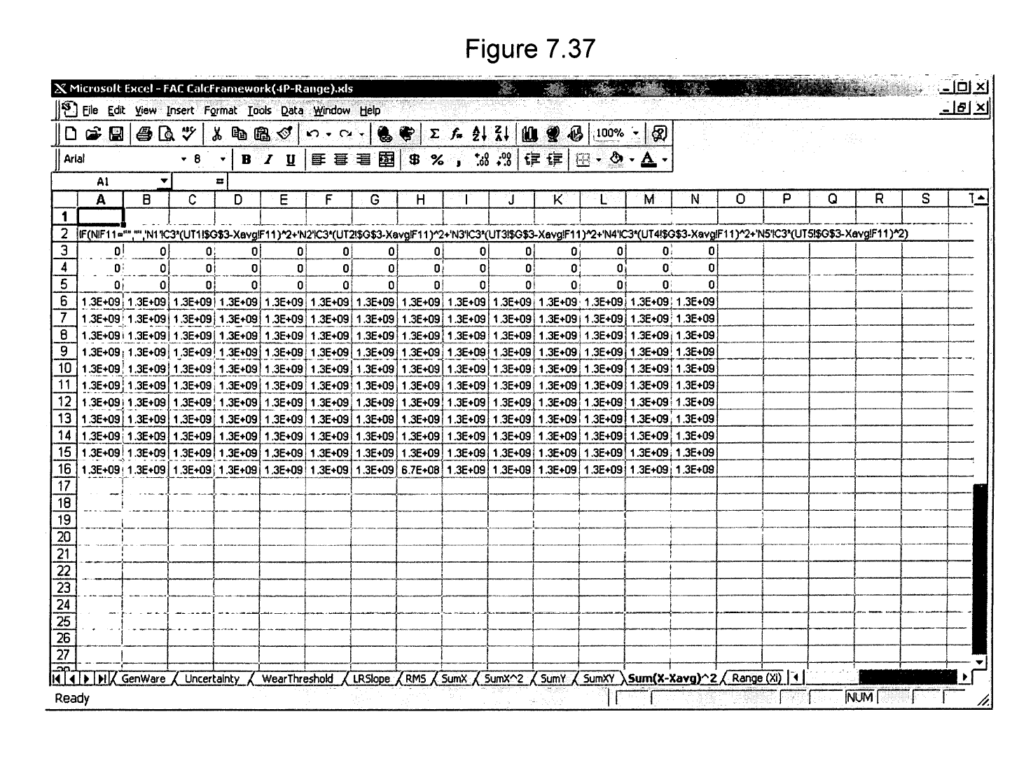

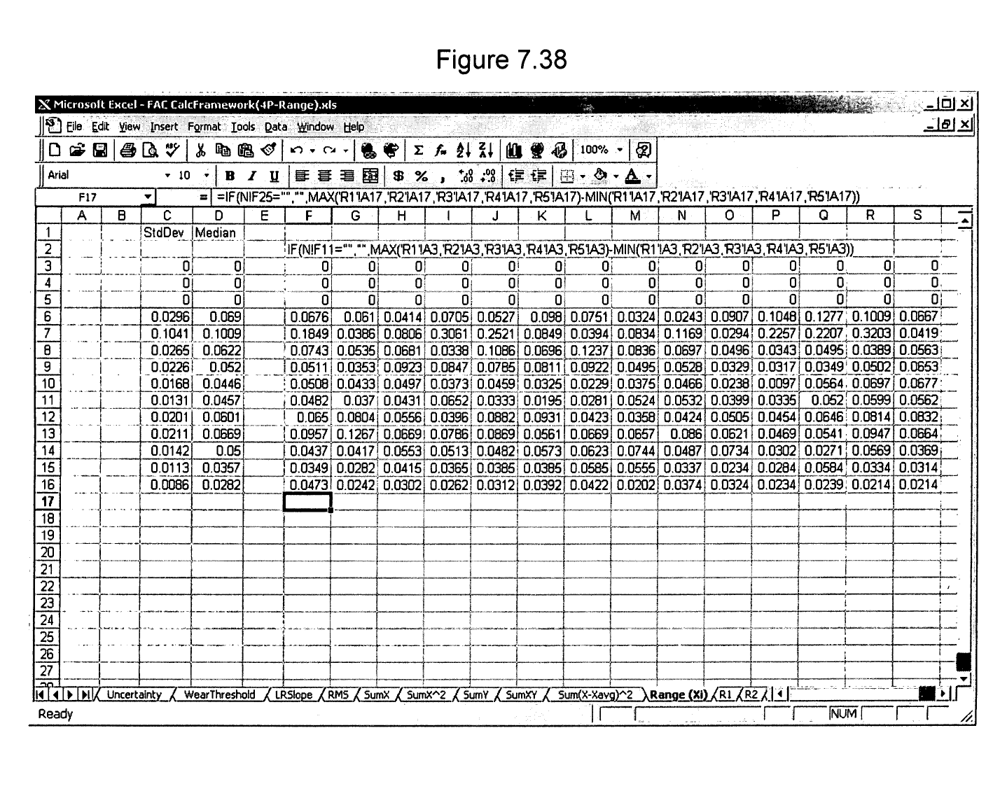

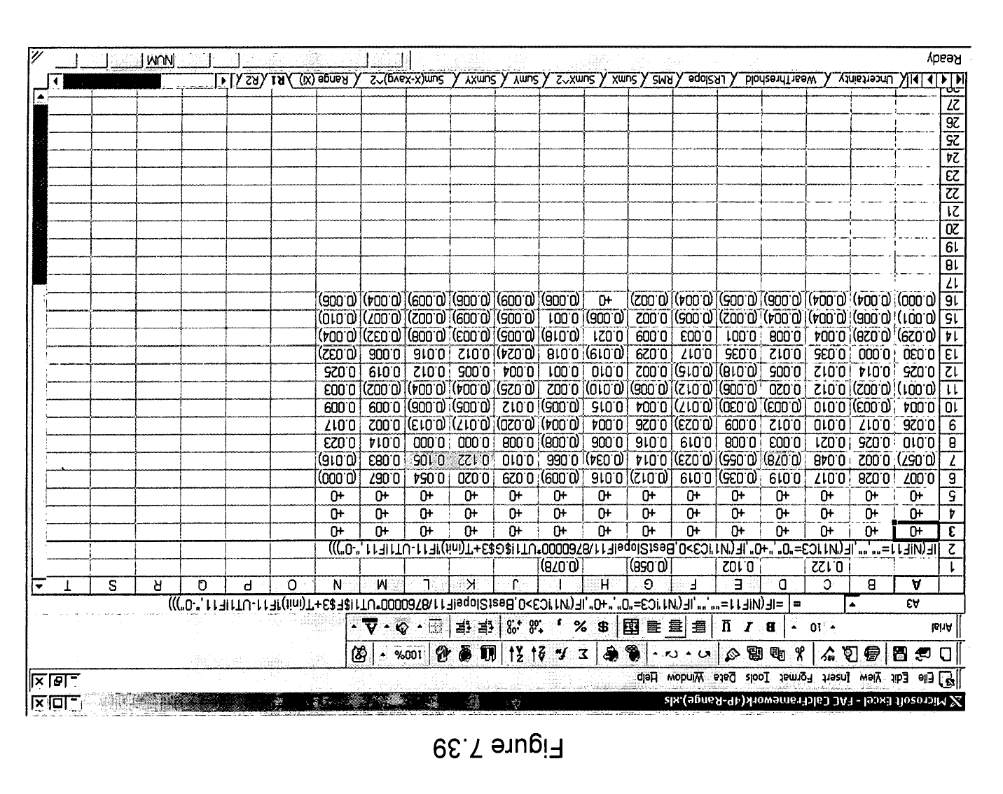

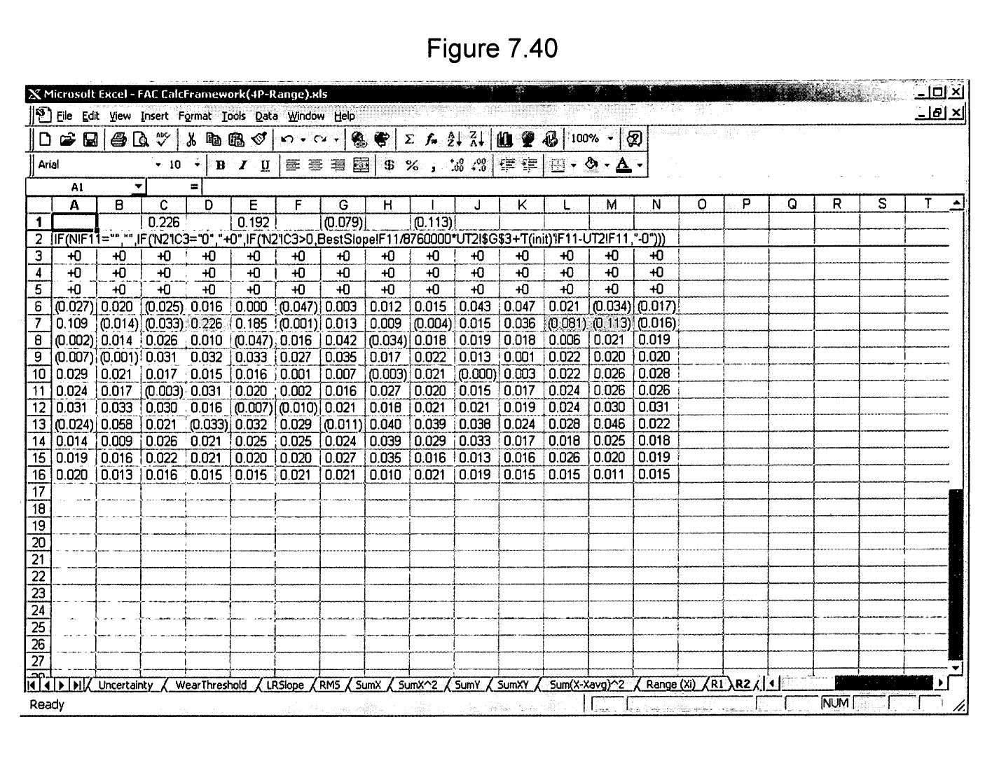

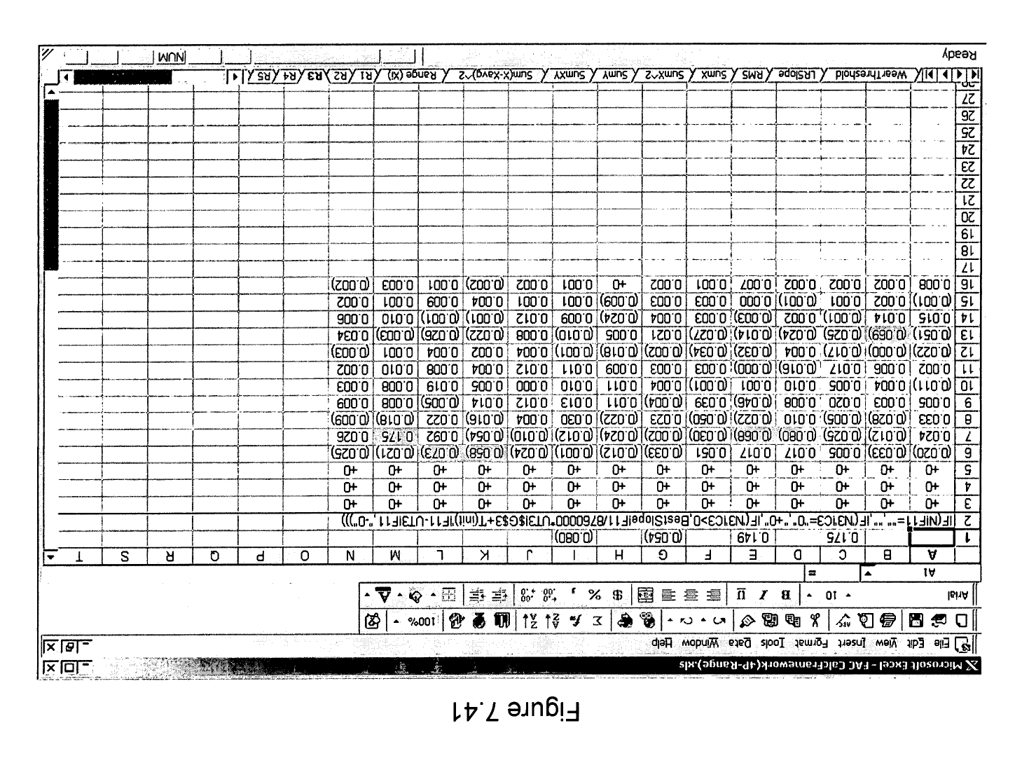

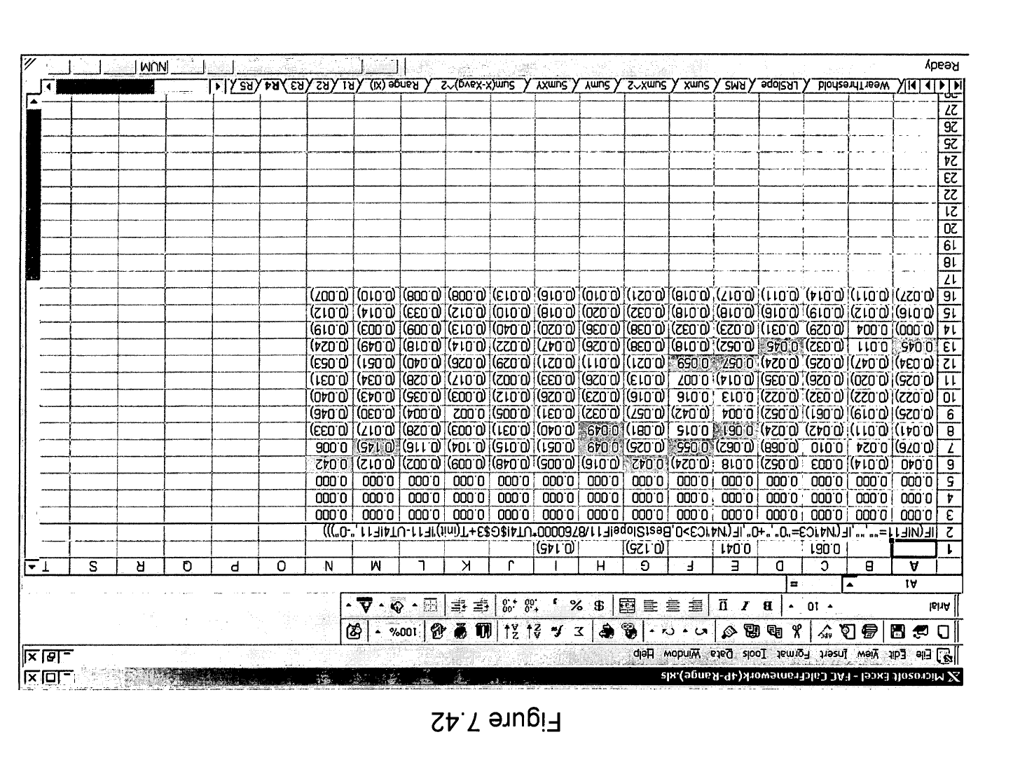

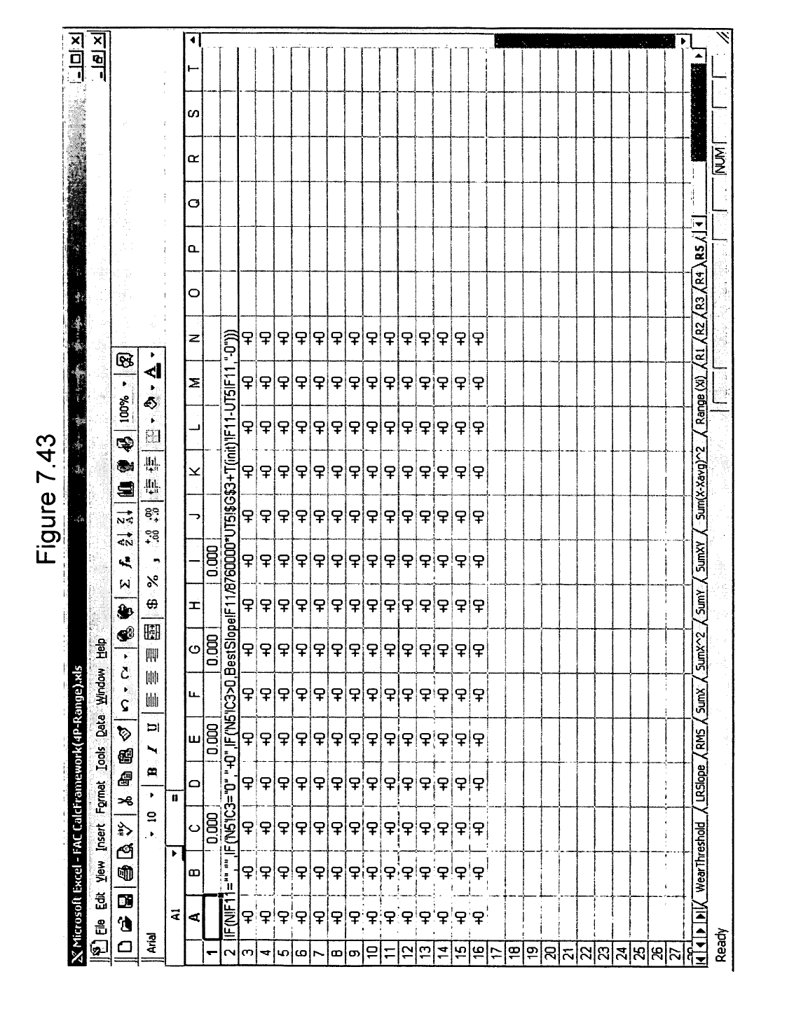

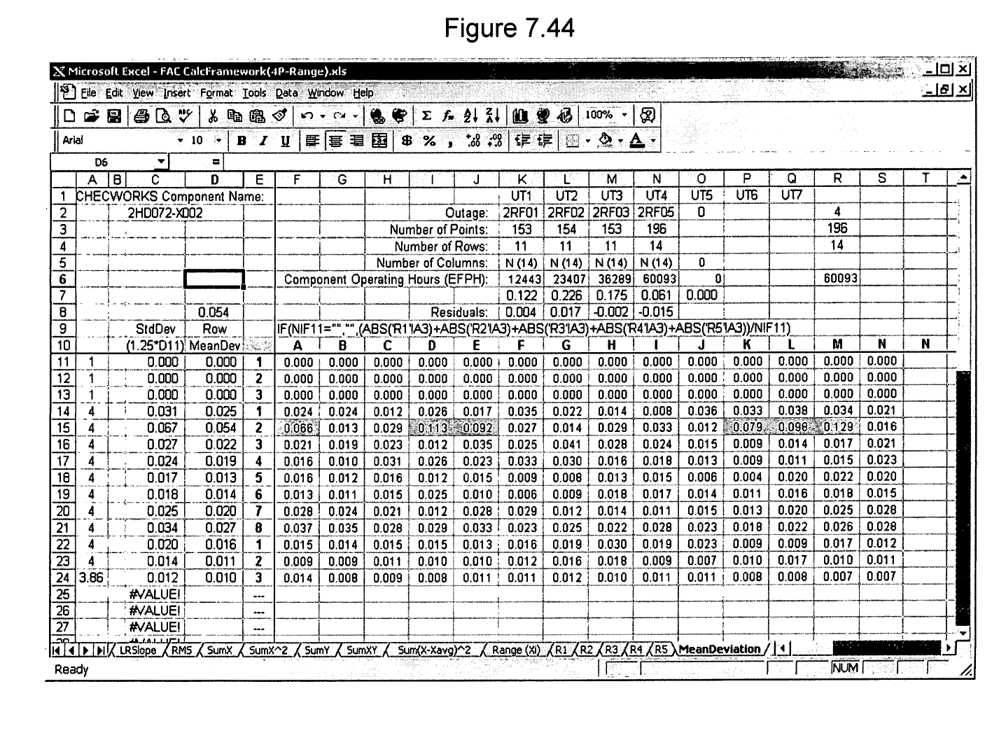

Referring to FIG. 5, there is shown a flow chart illustrating an exemplary method for analyzing wall thickness of a component in accordance with an embodiment of the present disclosure. According to this embodiment, the exemplary method may be implemented with a series of Microsoft® Excel spreadsheets or worksheets as illustrated in FIGS. 7.1-7.44. These worksheets also list embedded equations to calculate cell values where applicable.

In step 502, wall thickness data at each grid location on the component may be provided. The wall thickness data may be obtained at specified times with any currently known or later developed measurement tools and methods. For this particular embodiment as illustrated in the worksheets, the wall thickness data are from ultrasonic thickness (UT) measurements.

The UT thickness data may be input with worksheets UT1-UTS as shown in FIGS. 7.1-7.5, wherein each worksheet includes one data set. For example, the worksheet UT1 in FIG. 7.1 includes Data Set Number 1 as indicated in the upper left quadrant. In the upper right quadrant, there are shown the component name “2HD072-X002,” an outage name (or inspection incident) “2RF01,” the component and plant operating hours at the time of inspection, and an indication of data set reliability. The operating hours are shown in effective full power hours (EFPH). Also shown in the upper right quadrant are the number of rows (11) and number of columns (14) in the grid. The measured wall thickness data (in inches) are shown in an 11 by 14 matrix in the lower right quadrant. All the thickness data were measured at the time when the component and the plant had been in full-power operation for 12443 hours or 1.4 years. The rows of the grid correspond to different portions of the component, such as upstream extension (U.E.), upstream main (U.Mn.), downstream main (D.Mn.), and downstream extension (D.E.). Other portions of the component may include branch (Br.) and branch extension (Br.E.), for which no data is shown. The thinnest grid location for each portion of the component is underlined and also listed in the upper left quadrant. The average thickness and standard deviation for each row is shown in the lower left quadrant as columns B and C respectively on the Excel sheet.

It should be noted that some of the matrix points in the lower right quadrant are empty. That is, UT thickness data are not available for all the grid locations. For example, in FIG. 7.1, there is no data for any of the grid locations associated with the upstream extension (U.E.). Nor is there a thickness datum for grid location (14, H) (or Cell M24 of the Excel sheet). With the U.E. data missing, there are only 11 rows instead of 14 rows of thickness data available. And with the grid location (14, H) datum missing, there are a total of 153 data points in the matrix. Similarly, the worksheet UT2 in FIG. 7.2 lists 154 thickness data points in its matrix with U.E. data missing, where the thickness data were obtained at a time when the component had been in operation for 23407 hours. The worksheet UT3 in FIG. 7.3 lists 153 thickness data points in its matrix with U.E. and (14, H) data missing, where the thickness data were obtained at a time when the component had been in operation for 36289 hours. The worksheet UT4 in FIG. 7.4 lists 196 thickness data points in its matrix (with U.E. data available), where the thickness data were obtained at a time when the component had been in operation for 60093 hours. The worksheet UT5 in FIG. 7.5 lists no thickness data at all. Due to the set-to-set variation in data availability for certain grid locations, some matrix points such as those for the U.E. locations have a single set of thickness data (N=1), some matrix point such as grid location (14, H) has two sets of thickness data (N=2), and others have four sets of thickness data (N=4).

Referring back to FIG. 5, in step 504, a critical wall thickness value (or T_{crit}) may be provided for each grid location. Input of the T_{crit} values may be accomplished with a worksheet T_{crit} as shown in FIG. 7.6. For each portion of the component, the critical wall thickness values for the various grid locations therein may be the same. Therefore, a same critical thickness may apply to grid locations in a same row as well as adjacent rows that correspond to a same portion of the component. In FIG. 7.6, all the upstream grid locations have a same critical thickness of 0.159 inches, and all the downstream grid locations have a same critical thickness of 0.331 inches. The critical thickness value may be determined in a number of ways. For example, it may be dictated by industry standards such as ASME standards or government regulations. Or, the critical thickness may be determined based on a percentage (e.g., 87.5%) of the component manufacturer's nominal wall thickness specification. The critical thickness values can also accommodate local variations if the ASME code case N-597 analysis is adopted.

In step 506, the wall thickness data may be partitioned according to different portions of the component the grid locations correspond to, and thickness variations due to counterbore may be identified and quantified. This step may be accomplished with the worksheet “Partition” as shown in FIG. 7.7. A number of input fields are provided in the lower right quadrant where the different rows of thickness data may be declared as corresponding to different portions of the component. A designation of a row to a particular portion may cause corresponding changes in other worksheets automatically. In addition, some significant difference in wall thickness between adjacent rows may be attributed to artificial modification of the corresponding portion(s) of the component. For example, a letter “c” in Cell N14 on the Excel sheet indicates that the approximately 60% thickness change from U.Mn. Row 2 to U.Mn. Row 1 is due to a counterbore at the mouth of the upstream main pipe to accommodate the upstream extension pipe.

In step 508, it may be determined, for each grid location, how many thickness data points are available. As described above, in each data set, thickness data for one or more grid locations may not be available. When multiple data sets are combined, the number of available thickness data for each grid location may vary. Worksheets N1-N5 as shown in FIGS. 7.15-7.19 may help detect data presence in the grid locations for the data sets UT1-UT5 respectively. Combining worksheets N1-N5, worksheet “N” in FIG. 7.20 displays an overall count of available thickness data for each grid location.

If there is only one thickness datum available for a particular grid location (i.e., N=1), the process may branch to step 510 where it is determined whether the component has been in operation for over 15,000 hours. If not, the single thickness datum may be treated as a baseline inspection, and analysis for this particular grid location may end in step 512.

If the component has been in operation for over 15,000 hours, then, in step 516, an 85% upper confidence bound may be established for the thickness data in the same row to which this particular grid location belongs. To calculate the 85% upper bound, a maximum credible wear based on CHECWORKS predicted wear rate may be automatically imported in step 514. CHECWORKS calculates the predicted wear rate (99% ranked component wear rate) based on operating conditions for the component. The 99 percentile wear rate is typically plant-specific. When this predicted wear rate is multiplied by the amount of time the component has been in service, a predicted maximum wear value may be obtained. This predicted maximum wear value may be used to qualify the measured wall thickness data. According to one embodiment, the 85% upper bound value may be used an initial thickness at an N=1 location.

Then, in step 518, a best estimate wear rate may be calculated based on the single datum for this particular grid location and the 85% upper bound value established in step 516. The estimated wear rate may be displayed in worksheet “LRSlope” (FIG. 7.31).

In step 520, an initial wall thickness Tᵢₙᵢₜ may be synthesized by projecting backwards from the single thickness datum based on the estimated wear rate. With worksheets “T(calc)” (FIG. 7.23) and “T(del)” (FIG. 25) as inputs, the synthesized initial thickness values may be displayed in worksheet “T(init)” (FIG. 7.12).

If there is more than one thickness datum available for a particular grid location (i.e., N>2), then, in step 522, a wear rate may be calculated by applying a linear regression algorithm to the two or more thickness data and their respective inspection times. Using worksheets shown in FIGS. 7.33-7.36, and treating inspection time (in hours) as X and thickness (in inches) as T in the equation below, a wear rate (W.R.) or slope may be calculated for each grid location that has two or more thickness data.

$$Slope = Wear Rate = 8760000 \times \frac{N \sum X T - \sum X T}{N \sum {X}^{2} - {( \sum X )}^{2}}$$

The equation is based on the linear assumption:
T=W.R.×X+Tᵢₙᵢₜ
wherein Tᵢₙᵢₜ is the initial wall thickness. The calculated wear rates, in mils per year (mpy), are shown in worksheet “LRSlope” in FIG. 7.31. Note that the estimated wear rates for N=1 are also shown in FIG. 7.31. It should also be noted that some of the wear rates shown are positive numbers (i.e., wall thickness is growing), which have no physical meaning and may be attributed to measurement uncertainties. As such, those grid locations with wear rates greater than zero may have their wear rates reset to zero as shown in worksheet “Slope(calc)” (FIG. 7.24), and the corresponding thickness may be set to a data centroid X_{avg} as will be described below.

In step 524, the data centroid for the particular grid location may be established by calculating an average thickness T_{avg} and an average operation time X_{avg} from the two or more thickness data and the corresponding inspection times. The data centroid (X_{avg}, T_{avg}) may be calculated and displayed through worksheets “Tavg” and “Xavg” which are shown in FIGS. 7.14 and 7.22 respectively.

In step 520, the initial wall thickness Tᵢₙᵢₜ may be synthesized by projecting backwards from the data centroid (X_{avg}, T_{avg}) based on the wear rate calculated in step 522.
Intercept=Tᵢₙᵢₜ=T_{avg}−W.R.×X_{avg}
The initial wall thickness values may be calculated and displayed in worksheet “T(init)” (FIG. 7.12). Note that the Tᵢₙᵢₜ values for N=1 grid locations are also displayed in the same worksheet.

The above-described steps 508 through 524 may be repeated until the thickness data for all the grid locations have been processed.

In step 526, potential circumferential wear patterns may be checked row by row. Generally, flow accelerated corrosion (FAC) attacks only local areas around a circumference of the component, such that most grid locations experience negligible material loss. Occasionally, however, FAC can affect the entire circumference. To identify a potential circumferential wear pattern, it may be beneficial to compare average thickness between different rows or portions of the component. This may be achieved with worksheet “GenWare” (FIG. 7.28), wherein an average initial wall thickness is calculated for each row, and an average thickness is calculated for each row and for each inspection or data set. The average initial wall thickness values are shown in column H of the Excel sheet, and the average row thickness values are shown in columns I through M. The simultaneous and graphical display of these thickness values may expose the existence and location of a potential circumferential wear pattern.

In step 528, data outliers in the wear rates and thickness values of the grid locations may be detected and corrected. For example, outliers in the thickness data, especially in single-inspection data (N=1), may be filtered out by establishing a probably range of thickness value based on data uncertainty within a given row. That is, thickness data within the row may be treated as a normal distribution. The middle 50% of the normal curve may be considered the most probable thickness range. This assumes that thickness data within a same row are subject to the same errors. Therefore, the statistical characteristics of thickness data in a row may be “borrowed” to qualify each individual thickness datum in that row. In FIG. 7.23, the 50% probable thickness range for each row is shown in the lower left quadrant in columns C and D of the Excel sheet. The data outliers may also be corrected for the best estimate wear rate data. As described above, a maximum percentile (e.g., 99%) wear rate predicted by CHECWORKS may be used to eliminate or correct outliers in the wear rate data. In FIG. 7.24, the worksheet “Slope(calc)” corrects positive wear rates to zero. In FIG. 7.25, the worksheet “T(del)” smoothes wall thickness values for the grid locations based on a comparison between the average wear rates and those calculated in CHECWORKS. According to a preferred embodiment, the correction of outliers for thickness and wear rate data may be coordinated and iterative. That is, a correction of a wear rate outlier may lead to a correction in the corresponding thickness data and vice versa.

In step 530, a credible wear rate threshold may be established for each row. The wear rate threshold may be defined to correspond with roughly a 50% probability of detection (POD) threshold. Worksheet “WearThreshold” in FIG. 7.30 may be used to calculate the wear rate threshold. The threshold generally applies to an entire row wherein any wear rate below the threshold is considered to be random noise.

In step 532, a small population uncertainty may be calculated for each row. Referring to worksheet “Uncertainty” in FIG. 7.29, there are shown in the lower right quadrant data uncertainties calculated based on a 90% confidence threshold. According to embodiments of the disclosure, a desired confidence threshold may be specified by a data analyst to reflect confidence margin established in prior inspections. If the plant is excellent compliance with regulatory codes, the desired confidence threshold may be lowered to 50%, for example. Column D in the lower left quadrant shows an estimated tolerance limit for each row depending on the available number of data sets as well as the data range for that row. In one embodiment, the data variability for each row (calculated from the standard deviations in column C) may be multiplied with the corresponding tolerance limit to generate the uncertainty value to that row.

In step 534, the extent of wall thickness margin lost at each grid location may be calculated and displayed in worksheet “Pattern” as shown in FIG. 7.10. The lost margin, defined as the observed wall loss divided by a maximum acceptable wall loss, may be calculated based on the best estimate wear rate for each grid location. The wear rates used herein may have been filtered with the 50% probable wear threshold described above. In FIG. 7.10, the grid locations whose wear rates have been filtered show no data. The shaded matrix points have valid wear rates and lost margin. The matrix points may be color-coded where the particularly high lost margin values may be shown in red.

In step 536, the best estimate wear rates for the grid locations may be calculated and displayed in worksheet “BestSlope” as shown in FIG. 7.9. In this graphical display, the wear rates for N=1 and N≧2 cases are combined. The shaded matrix points represent those wear rates that are considered valid according to the 50% probable wear threshold. The output matrix can also be color-coded to indicate fast-wearing portions of the component.

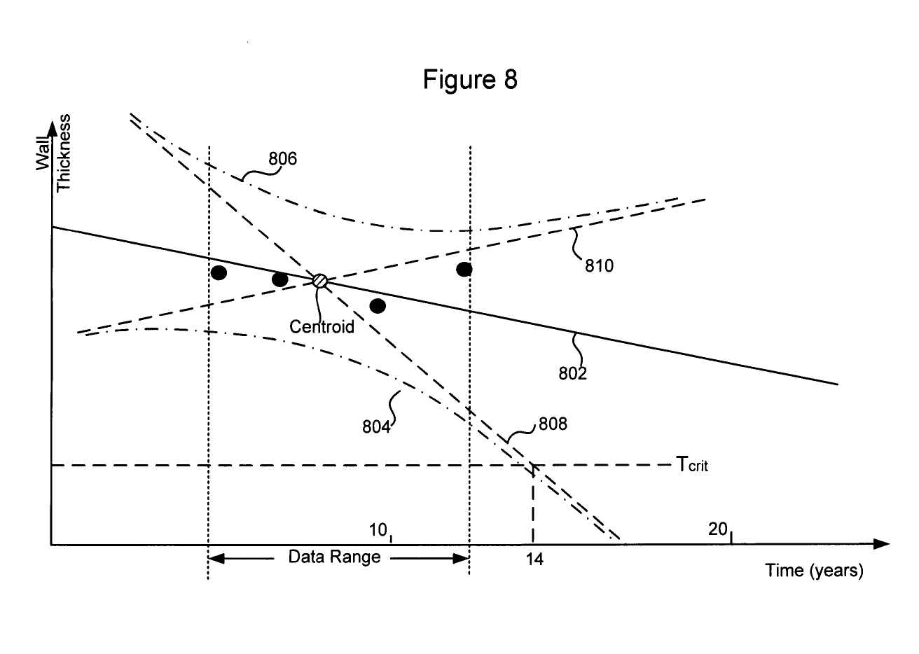

In step 538, the remaining lifetime for each grid location may be calculated and displayed in worksheet “TimeTcrit” as shown in FIG. 7.8. The numbers in the lower right quadrant are 90% lower confidence bound on remaining component life (until T_{crit}) expressed in 18-month cycles. For grid locations with multiple thickness data (i.e., N≧2), the time to T_{crit} may be determined with the asymptote lines that approximate the 90% upper and lower confidence bound hyperbolic curves. Referring to FIG. 8, there is shown a linear regression plot for a grid location having four (N=4) data points. The linear regression line 802 passes through the data centroid. Hyperbolic curves 804 and 806 represent the 90% lower and upper confidence bounds for this set of thickness data. The asymptote lines 808 and 810 also pass through the centroid and approximate the hyperbolic curves 804 and 806. The intercept between the asymptote line 808 with the T=T_{crit} line gives a close estimate of the remaining lifetime for this grid location on the component.

In the lower left quadrant of FIG. 7.8, there are shown interval percentages (column C) for each row. For N=1 rows, the interval percentages are inapplicable, and the operation hours at the last inspection are displayed. For N≧2 cases, the interval percentages are calculated in worksheet “Xinterval” (FIG. 7.21). The interval percentage for a grid location is a ratio between the sum of measurement intervals and the total operating interval. The interval percentages may serve as an input to determine how credible the remaining lifetime forecast is. A synthesized credibility index of 60% is calculated in worksheet “Xinterval” and shown in FIG. 7.8.

In step 540, an optional interface with CHECWORKS may be provided such that the above-described output data may be viewed in a familiar context for CHECWORKS users. For example, the lifetime wear and wear rates established in CHECWORKS may be matched or compared with the wear rates output described above. Worksheet “CWOut” shown in FIG. 7.11 provides an exemplary interface with CHECWORKS. In step 542, the users may also input a “desired time to next inspection” in the worksheet “CWOut.”

According to an embodiment, a corrected linear regression line may be established for each grid location. The line may pass through a synthesized initial thickness data point, the thickness data centroid, and a last inspection data point. Based on the corrected linear regression line, a mean deviation may be determined based on the distance between thickness data points for the grid location and the corrected line.

It should be noted that the exemplary worksheets shown in FIGS. 7.1-7.44 are just one embodiment of a wall thickness data analysis tool. In addition to or instead of worksheets, embodiments of the present disclosure may be implemented with either specifically designed or customized software programs.

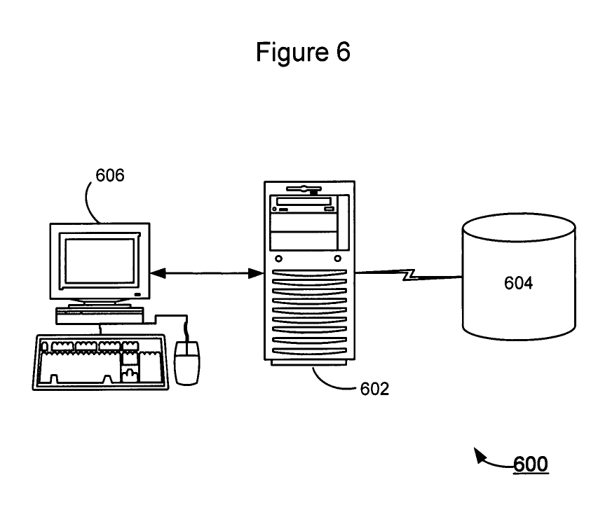

FIG. 6 is a block diagram illustrating an exemplary system 600 for analyzing wall thickness of a component in accordance with an embodiment of the present disclosure. The system 600 may comprise a processor unit 602 which may be a microprocessor, micro-controller, personal computer (PC) or any other processing device. The processor unit 402 may be coupled to a storage device 604 that stores UT thickness data, grid definitions, worksheets and related software program, for example. The system 600 may further comprise a user interface 606 through which a user may input data, execute commands, and view numerical or graphical display of output data.

At this point it should be noted that the technique for wall thickness analysis in accordance with the present disclosure as described above typically involves the processing of input data and the generation of output data to some extent. This input data processing and output data generation may be implemented in hardware or software. For example, specific electronic components may be employed in a computer or processor or similar or related circuitry for implementing the functions associated with wall thickness analysis in accordance with the present disclosure as described above. Alternatively, one or more processors operating in accordance with stored instructions may implement the functions associated with wall thickness analysis in accordance with the present disclosure as described above. If such is the case, it is within the scope of the present disclosure that such instructions may be stored on one or more processor readable carriers (e.g., a magnetic disk), or transmitted to one or more processors via one or more signals.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method for analyzing wall thickness of a component, the method comprising the steps of:
providing a plurality of thickness data for a plurality of locations on the component, wherein one or more thickness data measured at specified times are provided for each location;
partitioning the plurality of thickness data into subsets that correspond to one or more portions of the component; and
determining, for a first location associated with a first portion of the component, a first wear rate according to a statistical method selected based on the number of thickness data available for the first location.

2. The method according to claim 1, wherein the statistical method comprises the following steps if there is a single thickness datum available for the first location:
synthesizing an initial thickness for the first location; and
estimating the first wear rate based at least in part on the synthesized initial thickness and the single thickness datum.

3. The method according to claim 1, wherein the statistical method comprises the following step if there are two or more thickness data available for the first location:
applying a linear regression algorithm to the two or more thickness data and their respective measurement times, thereby deriving the first wear rate.

4. The method according to claim 3, further comprising:
estimating an initial thickness for the first location based on the first wear rate and a centroid of the two or more thickness data.

5. The method according to claim 1 further comprising:
evaluating an uncertainty for the first wear rate based on a probabilistic wear threshold derived from a subset of thickness data, the subset of thickness data being associated with the first portion of the component.

6. The method according to claim 1 further comprising:
calculating an uncertainty for the first wear rate based on a variability derived from a subset of thickness data, the subset of thickness data being associated with the first portion of the component.

7. The method according to claim 1 further comprising:
determining whether the first wear rate is an outlier, wherein the determination is based on a tolerance limit derived from a subset of thickness data, the subset of thickness data being associated with the first portion of the component; and
correcting the first wear rate if it is an outlier.

8. The method according to claim 1 further comprising:
determining a remaining lifetime for the first location based on a critical thickness value for the first portion of the component.

9. The method according to claim 8, wherein the remaining lifetime represents a 90% lower confidence bound value for the lifetime of the first portion.

10. The method according to claim 1 further comprising:
determining, for each of the plurality of locations, a remaining lifetime and an uncertainty associated with the remaining lifetime; and
displaying the remaining lifetimes graphically for the plurality of locations.

11. The method according to claim 10 further comprising:
color-coding the graphical display of the remaining lifetimes based on the remaining lifetime uncertainties.

12. The method according to claim 1 further comprising:
determining, for each of the plurality of locations, a wear rate and an uncertainty associated with the wear rate; and
displaying the wear rates graphically for the plurality of locations.

13. The method according to claim 1 further comprising:
determining a thickness loss margin for each of the plurality of locations; and
displaying the lost margins graphically for the plurality of locations.

14. The method according to claim 1 further comprising:
identifying a circumferential wear pattern in the component based on an average thickness value calculated for each portion of the component.

15. The method according to claim 1, wherein the component comprises one or more elements selected from a group consisting of:
a pipe;
a pipe elbow;
a pipe joint;
an expander;
a reducer;
a vessel;
a T-junction; and
a lateral junction.

16. The method according to claim 1, wherein the step of partitioning further comprises determining a counterbore effect on one or more of the plurality of thickness data.

17. The method according to claim 1 further comprising:
predicting a time for a next inspection of the component based on the calculated wear rates.

18. The method according to claim 1, wherein the plurality of locations are defined by at least one grid.

19. The method according to claim 18, wherein the component is a pipe, and wherein a row in the at least one grid defines locations around a circumference of the pipe.

20. The method according to claim 1 further comprising adjusting a confidence factor for analyzing the plurality of thickness data based on a confidence margin established in one or more prior inspections of the component.

21. The method according to claim 1 further comprising correcting at least one outlier in the plurality of thickness data in response to a correction of a wear rate data outlier.

22. The method according to claim 1 further comprising establishing a tolerance limit for the first location based on an analysis of the thickness data available for the first location.

23. At least one signal embodied in at least one carrier wave for transmitting a computer program of instructions configured to be readable by at least one processor for instructing the at least one processor to execute a computer process for performing the method as recited in claim 1.

24. At least one processor readable carrier for storing a computer program of instructions configured to be readable by at least one processor for instructing the at least one processor to execute a computer process for performing the method as recited in claim 1.

25. A wall thickness data analyzer comprising:
a storage device that stores a plurality of thickness data for a plurality of locations on the component, wherein one or more thickness data measured at specified times are provided for each location; and
a processor operable to access the storage device and to perform the following:
partitioning the plurality of thickness data into subsets that correspond to one or more portions of the component; and
determining, for a first location associated with a first portion of the component, a first wear rate according to a statistical method selected based on the number of thickness data available for the first location.

26. The wall thickness data analyzer according to claim 25, wherein the statistical method comprises the following steps if there is a single thickness datum available for the first location:
synthesizing an initial thickness for the first location; and
estimating the first wear rate based at least in part on the synthesized initial thickness and the single thickness datum.

27. The wall thickness data analyzer according to claim 25, wherein the statistical method comprises the following step if there are two or more thickness data available for the first location:
applying a linear regression algorithm to the two or more thickness data and their respective measurement times, thereby deriving the first wear rate.

28. The wall thickness data analyzer according to claim 25, wherein the processor is further adapted to:
estimate an initial thickness for the first location based on the first wear rate and a centroid of the two or more thickness data.

29. The wall thickness data analyzer according to claim 25, wherein the processor is further adapted to:
evaluate an uncertainty for the first wear rate based on a probabilistic wear threshold derived from a subset of thickness data, the subset of thickness data being associated with the first portion of the component.

30. The wall thickness data analyzer according to claim 25, wherein the processor is further adapted to:
calculate an uncertainty for the first wear rate based on a variability derived from a subset of thickness data, the subset of thickness data being associated with the first portion of the component.

31. The wall thickness data analyzer according to claim 25, wherein the processor is further adapted to:
determine whether the first wear rate is an outlier, wherein the determination is based on a tolerance limit derived from a subset of thickness data, the subset of thickness data being associated with the first portion of the component; and
correct the first wear rate if it is an outlier.

32. The wall thickness data analyzer according to claim 25, wherein the processor is further adapted to:
determine a remaining lifetime for the first location based on a critical thickness value for the first portion of the component.

33. The wall thickness data analyzer according to claim 32, wherein the remaining lifetime represents a 90% lower confidence bound value for the lifetime of the first portion.

34. The wall thickness data analyzer according to claim 25, wherein the processor is further adapted to:
determine, for each of the plurality of locations, a remaining lifetime and an uncertainty associated with the remaining lifetime; and
display the remaining lifetimes graphically for the plurality of locations.

35. The wall thickness data analyzer according to claim 25, wherein the processor is further adapted to:
determine, for each of the plurality of locations, a wear rate and an uncertainty associated with the wear rate; and
display the wear rates graphically for the plurality of locations.

36. The wall thickness data analyzer according to claim 25, wherein the processor is further adapted to:
determine a thickness loss margin for each of the plurality of locations; and
display the lost margins graphically for the plurality of locations.

37. The wall thickness data analyzer according to claim 25, wherein the processor is further adapted to:
identify a circumferential wear pattern in the component based on an average thickness value calculated for each portion of the component.

38. The wall thickness data analyzer according to claim 25, wherein the processor is further adapted to:
predict a time for a next inspection of the component based on the calculated wear rates.

39. The wall thickness data analyzer according to claim 25, wherein the plurality of locations are defined by at least one grid.
